(19) United States
(12) Patent Application Publication
(10) Pub. No.: US 2013/0246119 A1
(43) Pub. Date: Sep. 19, 2013

(54) PROJECT RANKING AND MANAGEMENT SYSTEM WITH INTEGRATED RANKING SYSTEM AND TARGET MARKETING WORKFLOW

(71) Applicant: Bryan Slaughenhoupt, Deale, MD (US)

(72) Inventor: Bryan Slaughenhoupt, Deale, MD (US)

(73) Assignee: OMNIVINE SYSTEMS, LLC, Potomac, MD (US)

(21) Appl. No.: 13/988,718

(22) PCT Filed: Nov. 30, 2011
(86) PCT No.: PCT/US11/62571

§ 371 Date: May 21, 2013

Related U.S. Application Data
(60) Provisional application No. 61/418,586, filed on Dec. 1, 2010.

(51) Int. Cl. G06Q 10/06; G06Q 50/08

(52) U.S. Cl. CPC G06Q 10/0633; G06Q 50/08
USPC 705/7.27

(57) ABSTRACT

A system and method for targeting, processing, and managing project leads and reports for target marketing products and services through the use of analytics, data mining, and the application of numerical weights to data criteria to determine the projects with the highest probability of requiring a company's products and/or services, with the highest return, and to prioritize and sequence the projects accordingly while enabling real-time analysis, metrics, and workflow management. A user form component provides access to project leads, segregating information through various project stages and allowing the user to launch and access project management forms. The project forms correspond to the user, project ranking criteria, territories, and project phases, permit a user to access associated metric and workflow information, and view project details, management information, ranking metrics, categories, keywords, specifications keywords, targeted competitors, product details, contacts, participants, interactions, sales documents, targeted prospects, and digital documentation.

### CROSS-REFERENCE TO RELATED APPLICATIONS

The present patent application is based on, and claims priority from, U.S. provisional Application No. 61/418,586, filed Dec. 1, 2010, which is incorporated herein by reference in its entirety.

### BACKGROUND OF THE INVENTION

1. Field of the Invention

The present invention relates to project data, leads and reports management, for example, for construction projects. More specifically the invention relates to computer-based, real-time analysis, metrics, methods, information systems, and workflow management of target marketing efforts within a market research organization.

2. Description of Related Art Including Information Disclosed Under 37 CFR §§1.97 and 1.98

Various construction project lead services are currently available commercially. Examples include Reed Construction Data's Connect and McGraw Hill's Dodge Construction Projects and Leads both provide comprehensive and timely construction project leads and information to support architects, landscape architects, owners, planners, estimators, contractors, distributors and building product manufacturers in identifying, bidding and tracking leads in both the US and Canada.

U.S. Pat. No. 5,671,361 to Brown discloses a technique for project prioritization and scheduling, which is geared towards managing actual projects—priority values are ranked to determine an optimum schedule for all job tasks and activities.

U.S. Pat. No. 6,393,410 to Thompson discloses a process and system for listing information relating to a construction project over a computer network, which is geared towards estimating a construction project.

U.S. Pat. No. 6,581,040 to Wright discloses systems for providing enhanced communications for the managing of projects, and more specifically, for managing projects in particular project communications involving owners, managers, and bidding providers.

U.S. Pat. No. 6,850,891 to Forman discloses methods for developing a decision hierarchy and including data as well as judgments in the evaluation of alternatives. The decision processing and converting of raw data and judgments into value scores and priorities are used to improve decision processing computer systems. The combined use of hard data and personal judgment is so generic as to be applicable to any system that assigns priorities.

U.S. Pat. No. 6,871,181 to Kansal discloses a system for providing a standardization and commoditizing the process of technology contracts and creating a method for assessing, scoring, ranking and rating technology vendors for the purpose of comparing vendor bids on a project.

U.S. Pat. No. 7,139,732 to Desenberg discloses system, methods, and computer program products facilitating real-time service transactions between two or more users, including at least one client and at least one service provider. Service providers complete project profiles indentifying projects they wish to work on and clients complete project profiles identifying projects they would like to pay service providers to complete.

U.S. Pat. No. 7,330,821 to Wares discloses an electronic bid/proposal system for the construction industry, in which groups of people who work on projects together collaborate and store/share documents, and which involves design management, bid management, construction management, and operations management. In other words, Wares' system is for teams of people working on numerous projects to which they have access and that are related to their company. An integrated electronic commerce based construction industry bidding and project management system and methods, including document distribution, supply chain automation, and online auctioning. In a pre-construction setting the e-commerce based bidding and project management system and method provides for a user the means for participating and competing in the bidding and construction project management tasks.

U.S. Pat. No. 7,356,484 to Benjamin et al. relates to a method for creating a supplier-rating matrix for rating services of a supplier, and to automated supplier selection.

U.S. Pat. No. 7,548,883 to Lawrence relates to a construction industry risk management clearinghouse, and to a system, methods, apparatus, computer program code and means for gathering, organizing and presenting on a real time basis.

U.S. Patent Pub. No. 2003/0135401 of Parr discloses a method and process for program management in the field of building construction, which quantifies the need for a project, and which monitors tracks, and indicates progress through each of the phases, activities, process, and tasks of the project. The method and process are for use by entities that do not have experience managing construction projects from start to finish.

U.S. Patent Pub. No. 2003/0225683 of Hill et al. discloses an electronic bid/proposal system for the construction industry, which includes the publishing and sharing of project information through construction phases.

U.S. Patent Pub. No. 2004/0015367 of Nicastro et al. discloses a digital asset management system relating to construction projects.

U.S. Patent Pub. No. 2004/0186763 of Smith discloses a construction project management/monitoring system, which is used from the construction side, not the target marketing perspective.

U.S. Patent Pub. No. 2006/0026009 of Luhr relates to methods for the selection and presentation of checkpoints (such as building codes) used to inspect construction projects.

U.S. Patent Pub. No. 2008/0140485 of Williams discloses a set of work breakdown structure milestones and provides feedback mechanisms; and more particularly, a project assessment method and software featuring processes and tools for the ongoing assessment of large, business critical and high risk programs and projects.

U.S. Patent Pub. No. 2008/0015823 of Arnold et al. discloses an extensible building information model toolset, and relates to building information management (BIM).

U.S. Patent Pub. No. 2008/0195434 of Broughton relates generally to the field of contracting, construction, and project management—in particular materials, labor, scheduling, and billing of a construction project.

U.S. Patent Pub. No. 2009/0119144 of Goyal discloses a method, system, and program product for optimal project selection and tradeoffs for optimizing expected business value for a business, which includes a tool for estimating business value of one or more projects. The projects evaluated by the product are in-house projects, and the product allows project formulations to be modified to improve their valuation.

U.S. Patent Pub. No. 2009/0138378 of Suba et al. discloses a commerce system for exchanging sales leads.

Although there are commercially-available construction project leads and reports services, none of the above described services employs a ranking system integrated with a project management system and systematic workflow. It is to the solution of this and other problems that the present invention is directed.

### BRIEF SUMMARY OF THE INVENTION

It is accordingly a primary object of the present invention to provide a ranking system integrated with a project management system and systematic workflow for targeting, processing, and managing project leads and reports for the purpose of target marketing products and services.

It is another object of the present invention to enable the target marketing of products and services through the use of relational databases, multidimensional databases, heuristics, data sieving, expert and predictive analytic system techniques, data mining, applying numerical weights to project data criteria such as categories, keywords, and other factors to determine construction projects: 1) with the highest probability of requiring a company's products and/or services 2) with the highest return (product quantity and unit requirements), and to prioritize and sequence the projects in working order accordingly, while enabling real-time analysis, metrics and workflow management of target marketing efforts within a market research organization is disclosed.

These and other objects are achieved by a computer system for enabling real-time analysis and workflow management of marketing efforts targeting a plurality of projects for a user organization, wherein each of the projects has a lifecycle with multiple stages and each of the projects has project data associated therewith. The system includes memory, input means, storage means, and at least one processor. The memory has program instructions for performing market research analysis and reporting, customer relationship management, project management, sales and marketing, project workflow, and project ranking operations for the projects, corresponding to the stages of the lifecycles of the projects. The input means receives, enters, and edits the project data, customizable project criteria for use in analyzing the project data, and customizable numerical weights applied to the project criteria for ranking the importance of the project criteria to the user organization, where the numerical weights are based on the importance of the project criteria to the user organization. The storage means stores the project data, the project criteria, and the weights. The processor execute the program instructions for performing the market research analysis and reporting, customer relationship management, project management, sales and marketing, project workflow, and project ranking operations for the projects, corresponding to the stages of the lifecycles of the projects. These operations include accepting input including the entering and editing of project data, project criteria, and numerical weights applied to the project criteria, and the designation of a project as inactive; in response to the entering and editing of project data, calculating total weights for each of the projects in real time based on the numerical weights applied to the project criteria, and ranking the projects based on the total weights to identify projects having the highest business value to user organization and to prioritize and sequence the projects in working order accordingly; and generating displays of at least some of the project data and the ranking for the projects that are not designated as inactive.

A method for enabling real-time analysis and workflow management of marketing efforts targeting a plurality of projects for a user organization, using the computer system, includes the steps of accepting input including the entering, editing, deleting, and appending of project data; in response to the entering, editing, deleting, and appending of project data, calculating total weights for the projects based on the numerical weights applied to the project criteria and ranking of the projects based on the total weights to identify projects having the highest probability of requiring the user organization's products and/or services and having the highest return for the user organization; and generating a display of at least some of the project data and the ranking for each of the projects. The result is a real-time, workable and prioritized direct marketing to-do list which, with information pinpointing, presents those projects, prospects and opportunities that have the highest probability of requiring any variant of a user's products and/or services, and thus quantifies the reward potential of the project.

Although the invention is described below in connection with construction data, it will be appreciated by those of skill in the art that it is equally applicable for targeting, processing, and managing project data, leads and reports for the purpose of target marketing other products and services, for example in retail sales, and is not limited just to overcoming data and opportunity overload in the construction industry. It has potential for uses across the entire spectrum of information and data services, including medical research and treatment, risk management, and legal and business sectors.

### BRIEF DESCRIPTION OF THE SEVERAL VIEWS OF THE DRAWINGS

The invention is better understood by reading the following Detailed Description of the Preferred Embodiments with reference to the accompanying drawing figures, in which like reference numerals refer to like elements throughout, and in which:

FIG. 1 is a block diagram of the physical layout of a networked computer system including aspects of the invention.

FIG. 2 is a flowchart diagram of an organization's target marketing processes enabled by aspects of the invention.

FIG. 3 is a conceptual diagram of a software architecture that can be implemented on the networked computer system of FIG. 1.

FIGS. 4-21 are screen shots of a of a graphical user interface rendered as forms and sub-forms within the project management layer of the software architecture in accordance with the invention.

FIGS. 22A and 22B are pictorial diagrams showing a comparison between how targeting, processing, and managing construction project leads and reports for the purpose of target marketing products are conventionally developed and launched, versus how they are developed using the tools provided by the invention.

FIG. 23 is a pictorial project lifecycle and ranking change diagram showing how the project ranking application increases and/or decreases the rank of each project as it moves along in time while data continues to be added, modified, and analyzed throughout the lifecycle of the project while being processed in conjunction with the target marketing workflow process enablement.

FIG. 24 is a data flow diagram representing the flow of data through the system and how the system determines how to rank the projects.

### DETAILED DESCRIPTION OF THE INVENTION

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

The present invention is described below with reference to flowchart illustrations of methods, apparatus (systems), and computer program products according to an embodiment of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions can also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks.

The computer program instructions can also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

A typical personal computer or workstation a user might log on with would include typical components such as a bus for communicating information, and a processor coupled with the bus for processing information, random access memory, coupled to the bus for storing information and instructions to be executed by the processor. Random Access Memory also can be used for storing temporary variables or other intermediate information during execution of instructions by the processor, a read only memory coupled to the bus for storing static information and instructions for the processor, and a data storage device coupled to the bus for storing information and instructions. The data storage device can include a magnetic disk or optical disk and its corresponding disk drive can be coupled to the computer system. Also the system can be coupled via the bus to a display device, such as an LCD monitor, for generating a graphical user interface to display information to a computer user. The computer system further includes a keyboard and a cursor control, such as a mouse. Any other access devices for accessing a network are intended to be included in the invention. Such devices can include properly equipped and configured cellular phones and personal digital assistants.

The present invention is preferably practiced within a client/server programming environment. As is known by those skilled in this art, client/server is a model for a relationship between two computer programs in which one program, the client, makes a service request from another program, the server, which fulfills the request. Although the client/server model can be used by programs within a single computer, it is more commonly used in a network where computing functions and data can more efficiently be distributed among many client and server programs at different network locations.

As is known to those with skill in this art, client/server environments can include public networks, such as the Internet, and private networks often referred to as “Intranets” and “Extranets.” The term “Internet” shall incorporate the terms “Intranet” and “Extranet” and any references to accessing the Internet shall be understood to mean accessing an Intranet and/or and Extranet, as well. The term “computer network” shall incorporate publicly accessible computer networks and private computer networks.

In addition to public networks, such as the Internet, and private networks (“Intranets” and “Extranets”), other networks can be used, preferably capable of transmitting using any Network Protocol. The communication links between the entities for implementing the network preferably comprises a cable, fiber, or wireless link on which electronic signals can propagate. For example, each entity can be connected via an Internet connection using a public switched telephone network such as those provided by a local or regional telephone operating company. Alternatively, each entity can be connected by dedicated data lines, cellular, Personal Communication Systems, microwave, or satellite networks.

The following definitions are used herein:

“Submitting alternates”—Typically on a construction project, the architect, landscape architect, and/or specifier will select and specify the brand, model, color, etc. the contractor must acquire for a project. Sometimes the specifier will indicate that alternate products are acceptable. Such alternate products must be approved by the specifier before the contractor can purchase and install them. “Submitting alternates” is a process by which the contractor provides the specifier with all the pertinent product information to get approval from the specifier for the alternate products. The manufacturer of the products provides this information to the contractor to facilitate the submittals.

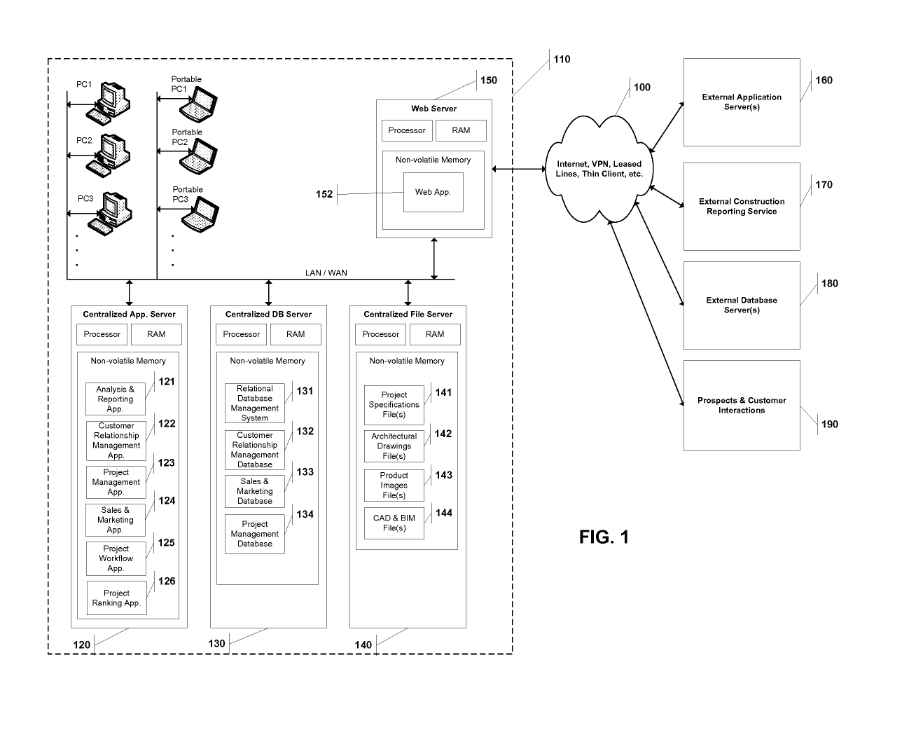

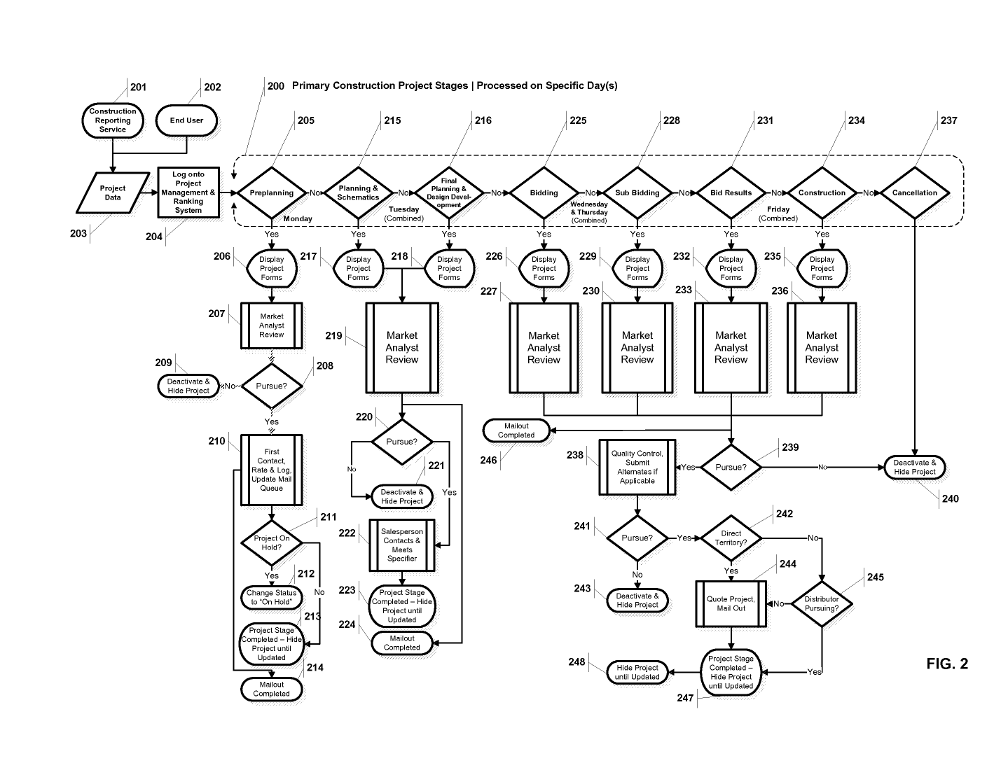

A computer-based system for enabling real-time analysis, metrics, methods, information systems, and workflow management of targeted marketing efforts within a market research organization in accordance with the present invention (hereafter, the “project management and ranking system,” which is designated as 204 in FIG. 2) can reside on a networked computer system 110 of the type shown in FIG. 1. The computer system 110 includes, in this example, only the computing resources of the market research organization and not third-party, or external, computing resources. FIG. 1 is only one example physical configuration for the system 110. As those skilled in the art will recognize, numerous variations from the physical configuration shown in FIG. 1 will be realizable without departing from the invention.

The exemplary computer system 110 shown in FIG. 1 includes various conventional centralized computer servers, namely, an application server 120, a database server 130, a file server 140, and a web server 150. The computing resources of the market research organization can be interconnected by wide area network (WAN) or local area network (LAN) connections, depending on the geographic extent of the market research organization. User personal computers (PC's), indicated as PC1, PC2, PC3, etc. in FIG. 1, can have access to the centralized servers 120, 130, 140, and 150 as is conventional, although individual access rights will typically vary from user to user.

The application server 120, as is conventional, stores applications that may not be available on the users' PC desktops, which can include software applications for implementing the project management and ranking system 204 in accordance with the present invention. The software applications available on the application server 120 are stored in the server's non-volatile memory.

In the case of a market research organization, typical software applications include those that assist in the market research functions of analysis and reporting, customer relationship management (CRM), project management, sales and marketing, workflow, and perhaps other functions. The software applications for implementing the project management and ranking system 204 consequently include an analysis and reporting application 121, a customer relationship management application 122, a project management application 123, a sales and marketing application 124, and a project workflow application 125, and perhaps other functions not shown in FIG. 1. Analysis and reporting applications, customer relationship management applications, project management applications, and sales and marketing applications are commercially available and can be used for the applications 121-124. In addition, the project management and ranking system 204 is implemented using a project ranking application 126.

As will be understood, a single software application may serve more than one of the indicated marketing functions. Also, in some cases, a software application may be available on one or more of the PC's, either in addition to being available on the application server 120 or instead of being available on the application server 120. Whether the software application is stored in the applications server or on the PC desktop is dictated by the computing resource demands of the application, pricing of the application, and other factors.

The web server 150, as is conventional, may serve as a gateway for access to external computer resources, via the Internet, a virtual private line (VPN) within the Internet, a private leased line, or some other connection. Persons within the market research organization having remote PC's (indicated as Portable PC1, Portable PC2, Portable PC3, etc.) can access the computer system 110 through the web server 150, as well as via the previously mentioned networks. In addition, the web server 150 can similarly provide PC's within computer the system 110 with access to external application server(s) 160, data from external construction reporting services 170, database servers 180, and prospects and customer interactions 190 (e.g., a call center, web forms, advertising literature and e-mail distributors, and advertising media).

In addition to serving as a gateway to external computing resources, the web server 150 can have stored in its non-volatile memory a web program 152 designed to interface with the invention using a web interface in place of a computer form (for simplicity the invention's graphical user interface (“GUI”) is described as a form, but a web interface could be used interchangeably). The project management program 123, as will be discussed in more detail later, generates a graphical user interface that allows users to retrieve interactive forms and display them on their PC's (for example, PC1, PC2, PC3, etc., and Portable PC1, Portable PC2, etc.) The project management program 123 may be in the nature of an “intranet” web-site, “extranet” web-site, or client-server application. A wide variety of software tools are known and available to create the web program 152 or the project management program 123. Use of these tools to create a project management program 123 having features that will be discussed later in this specification is well known in the art of software programming. In an embodiment that will be described later, relational database management systems (RDBMS), client/server application language (C/AL) within the client/server integrated development environment (C/SIDE), and structured query language (SQL) development tools available from Microsoft were used to create the project management application 123 and the project ranking application 126.

The project management application 123 and the project ranking application 126 comprise program instructions stored in non-volatile memory in the application server 120. These instructions are executed by a processor in the application server 120, upon requests being sent to the application server 120, for example, from personal computers PC1-PC3 or portable computers PC1-PC2. Also stored in the non-volatile memory of the application server 120 non-volatile memory are user accounts of the computer system 110. Each user has a unique identifier and configurations, so when a user accesses the application server 120 for access to the user's form, the application server 120, using the user's unique identifier, accesses the appropriate user account, and provides the user with the appropriate requested forms (territories and projects).

The file server 140, as is conventional, contains common files that many users may need to access. In the case of a market research organization, the typical files, again shown in FIG. 1 stored in non-volatile memory, can include project specifications files 141, architectural drawings files 142, product image files 143, and Building Information Modeling (BIM) and Computer Aided Design and Drafting (CADD) files 144. The data contained within files 141-144 can also be indexed, and then queried by the project ranking application for inclusion within the overall ranking of each project.

The database server 130, as is conventional, provides database services to other computer programs or computers, as defined by the client-server model. The database server 130 stores, hosts, and manages the Relational Database Management System (RDBMS) 131, along with the databases stored in the server's non-volatile memory—a customer relationship management database 132, a sales and marketing database 133, and a project management database 134—and utilized by the project management application 123 and the project ranking application 126 and the application server 120.

Although the servers 120, 130, 140, and 150 are shown separately in FIG. 1, it will be understood that this is merely illustrative, and not intended to dictate a particular physical configuration. For example, a single server device can actually satisfy all of the server functions of application server 120, database server 130, file server 140, and web server 150. Also, multiple servers can make up each of the illustrated servers 120, 130, 140, and 150. These multiple servers can all be at a common location or can be distributed at different locations.

FIG. 2 is a process flow diagram illustrating an exemplary target marketing process in accordance with the invention, in which the primary project stages 200 of the target marketing process flow are indicated along the top of the figure, and include (1) a preplanning stage 205, (2) a planning and schematics stage 215, (3) a final planning and design development stage 216, (4) a bidding stage 225, (5) a sub-bidding stage 228, (6) a bid results stage 231, (7) a construction stage 234, and (8) a project cancellation stage 237. The days that may be required to dedicate to each of the stages are indicated on the figure. It will also be recognized that the number of days indicated on the figure are general estimates, and may be shorter or longer depending on the nature of the target marketing research, nature of the industry, and other factors. With that said, however, FIG. 2 gives an example of typical times a market research organization would need to focus on construction stages.

Project lead data 203 is downloaded through a data connection from at least one construction reporting service 201 and/or is manually entered by an end user (for example, a market research analyst employed by the market research organization) 202 who has logged on to the project management and ranking system 204. The end user 202 uses the project management application 123, and specifically using a project details form 400 rendered as part of a graphical user interface (block 206) by the project management application 123, as will be discussed in greater detail hereinafter in connection with the preplanning stage 205. Downloading is carried out either in response to an end user command to download raw data from the project lead service's FTP site, or automatically at predetermined time intervals, under the control of a computer application hosted either at the project lead service or at the end user's site. Where the downloading application is hosted at the end user's site, the downloaded data is imported into the project management database 134 stored in the database server 130. Where the downloading application is hosted at the construction reporting service 201, the downloaded data is linked to the project management database 134. The retrieved raw data 203 can be new, or it can be an addition or a modification to previously-downloaded data.

Stage 1 is preplanning 205. In stage 1 preplanning, the project management application 123 displays (at block 206) project user, workflow and ranking, and details forms 1600, 1700-2000, and 400 to a market research analyst via the graphical user interface. The project user, workflow and ranking, and details forms 1600, 1700-2000, and 400 collectively comprise the project management forms of the project management application 123. The market research analyst uses the forms to review each construction project lead (block 207) and then determines whether the project lead is worth pursuing (block 208). If the market research analyst determines that the project lead is not worth pursuing, the market research analyst deactivates the project lead and the project management application 123 in response hides the project from the market research analyst indefinitely (block 209). If the market research analyst decides that the project lead is worth pursuing, then (block 210) the market research analyst (1) makes first contact with the project participants, (2) rates and then logs the interaction with the participants and then (3) adds the contact(s) to the mailing queue. A packet of the market research organization literature and cover correspondence (a “mail out”) is completed (block 214) independent of the remaining steps in processing the project. Following the actions in block 210, the market research analyst determines if the project is on hold (block 211). If it is on hold, the market research analyst changes the project status to project on hold and the project management application 123 in response hides the project from the market research analyst until there is a project update (block 212). If the project is not on hold, the market research analyst changes the project status to project stage completed and the project management application 123 in response hides the project from the market research analyst until the project is updated, via data downloaded from the construction reporting service and/or based on information received via communication between the project participants and the market research organization (block 213). Stages 2 and 3 are respectively planning and schematics 215 and final planning and design development 216. In stages 2 and 3, the graphical user interface rendered by the computer system 10 (blocks 217 and 218) includes project user, workflow and ranking, and details forms 1600, 1700-2000, and 400, which are displayed to the market research analyst, who reviews, determines scope, contacts participants, determines specification timeframe, adds additional contacts to the mailing queue and updates the project record for each construction project lead (block 219). The mail out is completed (block 224) independent of the remaining steps in processing the project. Following the actions in block 219, the market research analyst determines whether the project lead is worth pursuing further (block 220). If the market research analyst determines that the project lead is not worth pursuing, the market research analyst deactivates the project lead and the project management application 123 in response hides the project from the market research analyst indefinitely (block 221). If the market research analyst decides the project lead is worth pursuing, the market research analyst gets a salesperson involved and attempts to set up a meeting between the project participants and the salesperson(s) (block 222), after which the market research analyst changes the project status to project stage completed and the project management application 123 in response hides the project from the market research analyst until there is a project update (block 223).

Stages 4 and 5 are respectively bidding 225 and sub-bidding 228. In stages 4 and 5, the market research analyst interacts with the system using the system's project user, workflow and ranking, and details forms 1600, 1700-2000, and 400 (blocks 226 and 229):

In the bidding stage 225, the market research analyst reviews the project specifications and site plans, contacts the participants, adds additional contacts to the mailing queue, determines if alternative products are permitted and how to go about submitting the appropriate submittal documentation and then updates the project record (block 227). The mail out is completed (block 246) independent of the remaining steps in processing the project.

In the sub-bidding stage 228, the market research analyst reviews the project specifications and site plans, contacts the participants (such as the awarded bidder), determines the subcontractors, adds additional contacts to the mailing queue, determines if alternative products are permitted and how to go about submitting the appropriate submittal documentation, and then updates the project record (block 230) The mail out is completed (block 246) independent of the remaining steps in processing the project.

Stages 6 and 7 are respectively bid results 231 and construction 234. In stages 6 and 7, the market research analyst interacts with the system using the system's project user, workflow and ranking, and details forms 1600, 1700-2000, and 400 (blocks 232 and 235):

In the Bid Results stage 231, the market research analyst reviews the project specifications and site plans, contacts the low bidder and/or awarded bidder, confirms that the quotation was acceptable, determines if a value engineered proposal is needed, determines the purchase date, adds additional contacts to the mailing queue, determines if alternative products are permitted and how to go about submitting the appropriate submittal documentation and then updates the project record (block 233). The mail out is completed (block 246) independent of the remaining steps in processing the project.

In the Construction stage 234, the market research analyst contacts the construction manager or project manager and determines if products are still needed, determines how to go about submitting the appropriate submittal documentation and quotation, and then updates the project record (block 236).

If the project management application 123 detects that the project has been cancelled (block 237), the project management application 123 deactivates the project lead and hides the project from the market research analyst indefinitely (block 240).

The steps following stages (1) preplanning 205, (2) planning and schematics 215, (3) final planning and design development 216, (4) bidding 225, (5) sub-bidding 228, (6) bid results 231, and (7) construction 234 are the same, and are as follows: The market research analyst determines whether the project lead is worth pursuing further (block 239). If the market research analyst determines that the project lead is not worth pursuing, the market research analyst deactivates the project lead and the project management application 123 in response hides the project from the market research analyst indefinitely (block 240). If the market research analyst decides that the project lead is worth pursuing, the market research analyst assigns the project to quality control (block 238), and in turn quality control reviews the project and determines if it is worth pursuing further (block 241). If quality control determines that the project lead is not worth pursuing, quality control deactivates the project lead, and the project management application 123 in response hides the project from the market research analyst indefinitely (block 243). If quality control decides that the project lead is worth pursuing, quality control determines if the territory in which the project is located is a direct territory (that is, a territory in which the market research organization itself handles sales) or a non-direct territory (that is, a territory in which a distributor handles sales on behalf of the market research organization) 242.

Non-Direct

If the project territory is non-direct, quality control assigns the project to the territory's distributor, who must decide whether to pursue the project (block 245). If the distributor decides to pursue the project, the market research analyst changes the project status to project stage completed (block 247) and the project management application 123 in response hides the project from the market research analyst until there is project update (block 248). If the distributor decides not to pursue the project, the market research analyst assigns the project to customer service to quote and add contacts to the mail out queue (block 244). Once the project is quoted, customer service changes the project status to project stage completed (block 247) and the project management application 123 in response hides the project from the market research analyst until there is a project update (block 248).

Direct

If the project territory is direct, quality control assigns the project to customer service to quote and add contacts to mail out queue (block 244). Once the project is quoted, customer service changes the project status to project stage completed (block 247) and the project management application 123 in response hides the project from the market research analyst until there is a project update (block 248).

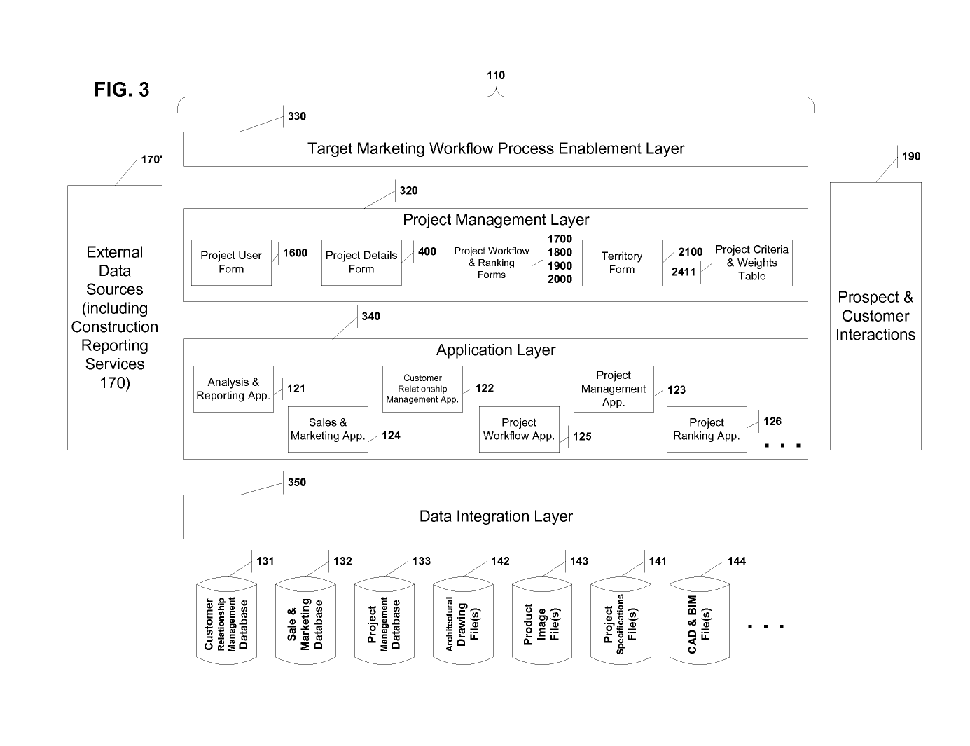

In FIG. 3, a conceptual depiction of the computer system 110 of FIG. 1 illustrates the software architecture of the system 110. This conceptual depiction is not dependent on the physical configuration of the system 110 shown in FIG. 1, as will be appreciated by those skilled in the technical field.

As mentioned previously, the computer system 110 of FIG. 1 includes a project management application 123, a project workflow application 125, and a ranking application 126, as well as an analysis and reporting application 121, a customer relationship management application 122, and a sales and marketing application 124, in accordance with the invention. From a conceptual standpoint, the computer system 110 includes a project management layer 320, a target marketing workflow process enablement layer 330, an application layer 340 (in which all the market research applications 121-126 are grouped), and a data integration layer 350 (a software layer that lies between the market research applications 121-126 and the databases 131-133, separate from the databases/files), as well as external data sources 170′ (including, but not limited to, external construction reporting services 170, Internet research, trade journal research, word of mouth, invitations to bid, project participant inquiries and quotations, distributor knowledge, research, newspapers, etc.) and prospects and customer interactions 190. In FIG. 3, the project management layer 320 is shown just below the target marketing workflow process enablement layer 330 in the conceptual depiction of the computer system 110 because the project management layer 320 provides users (market research analysts) with the graphical user interface and access to information and applications within the computer system 110. The project management layer 320 can be in the nature of an organization's “intranet” site, client-server application, or standalone system. The project management layer 320 includes the project user form 1600, the project details form 400, the project workflow and ranking forms 1700, 1800, 1900, and 2000, the territory form 2100, and the project criteria and weights table 2411, all of which will be described in greater detail hereinafter.

The workflow process enablement layer 330 is essentially a predetermined set of steps the user goes through at each major stage of the project lifecycle; the user uses the project management application 123 to work through these steps. The target marketing workflow process enablement layer 330 is shown above the project management layer 320, because the project management layer 320 provides direction how the workflow tools are to be utilized. Because there is workflow associated with each of the different market research applications 121-126, the workflow process enablement layer 330 is shown overarching the project management layer 320, the application layer 340, and the data integration layer 350 to completely integrate them within the market research organization. The data integration layer 350 integrates all of the databases 131-133 and files 141-144 together and provides a logical view of all of the information contained in all of the databases 131-133 and files 141-144. Finally, the external data sources 170′ and prospects and customer interactions 190 are shown to the sides of the computer system 110, but integrated with the computer system 110.

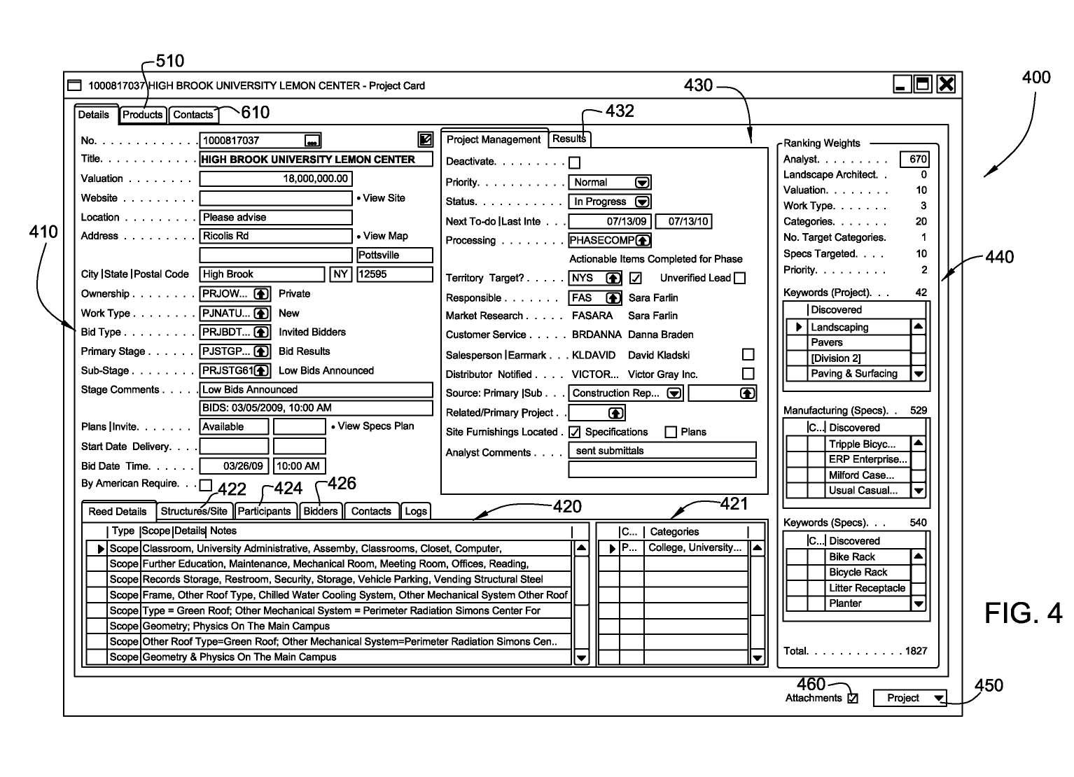

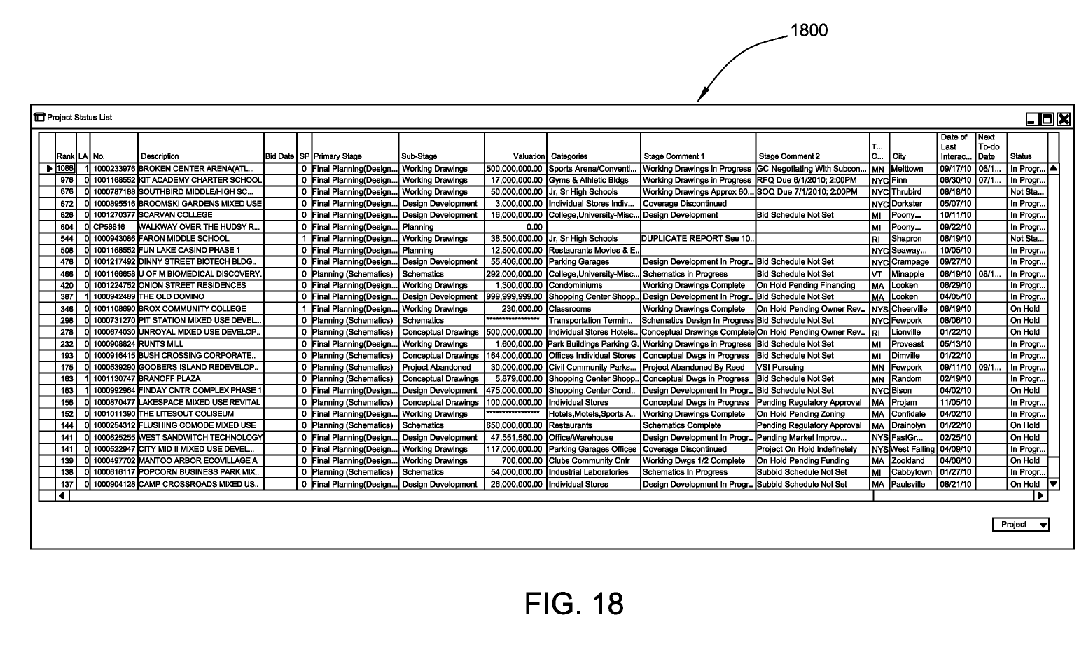

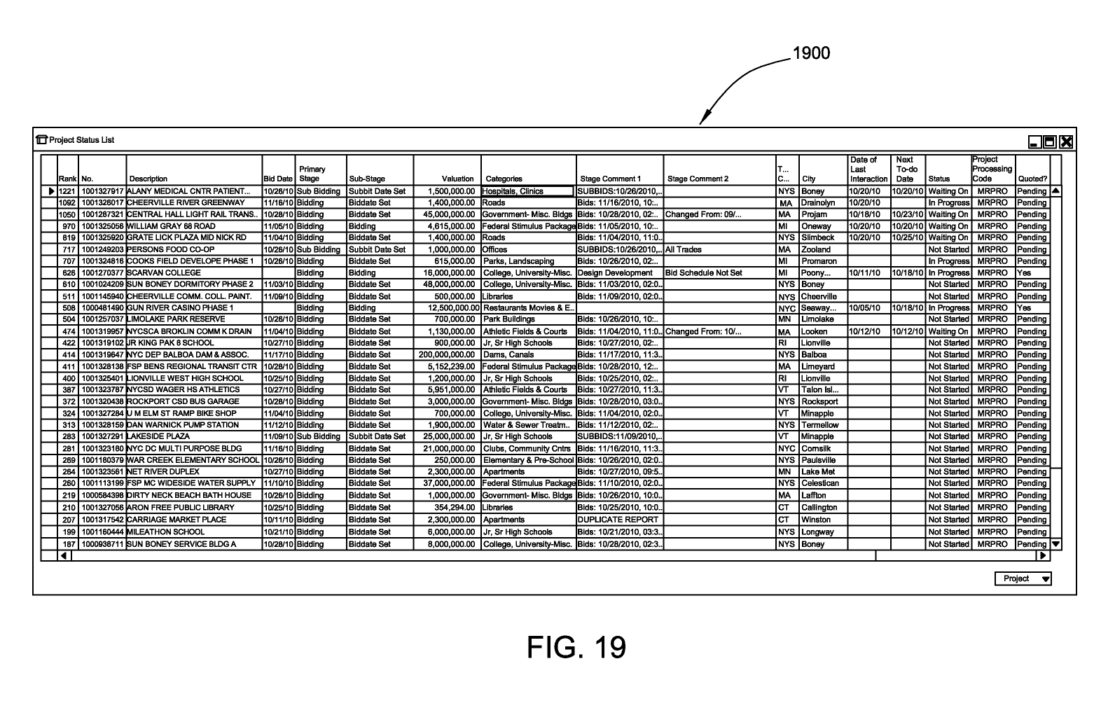

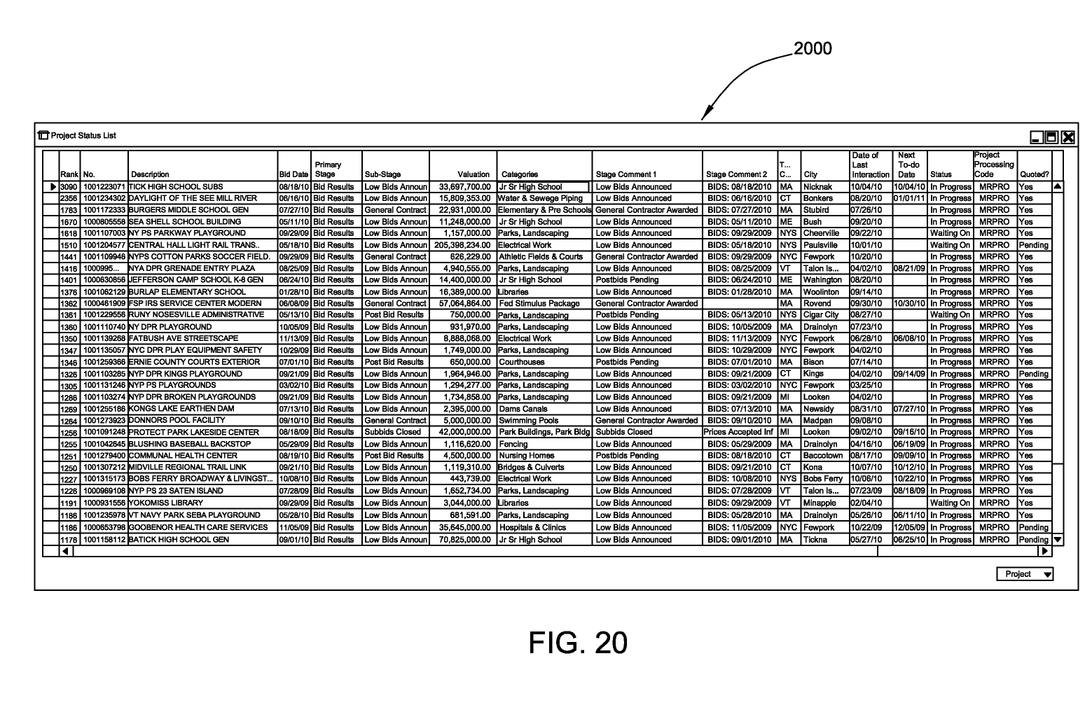

FIGS. 4-21 show example application forms displayed in the graphical user interface rendered by the project management application 123. In FIGS. 4-21, the application forms are for a market research organization for a fictitious commercial site furniture company.

FIG. 4 is an exemplary project details form 400 that includes a construction project report record for a market research user. The project details form 400 is a baseline form tailored to the needs of the type of role and company that the user serves in the market research organization. It is the aspect of the project management layer 320 that is displayed in the graphical user interface of the user's PC, and that permits the user to access software applications and market research information appropriate for the user's role. The project details form 400 includes the tools necessary to view, enter, edit, delete, append, and analyze the construction project data while processing the project through the primary stages of construction using the target marketing process illustrated in FIG. 2.

On the viewer's left side of the project details form 400 is a project summary 410. A variety of project information can be displayed and captured under this project summary 410. For example, the project summary 410 can include key project information such as project number, summary, valuations, location, ownership type, work type, primary stage, sub-stage, stage comments, and other critical information. The data contained within the project summary 410 can be viewed, entered, edited, deleted, and appended by the user or the project management and ranking system 204, at which time the project ranking application 126 analyzes the data and adjusts the project ranking accordingly.

On the viewer's bottom left side of the project details form 400 are six tabs: a project details tab 420, a structures/site tab 422, a participants tab 424, a bidders tab 426, a contract tab, and a log tab, the details tab 420 being selected for display in FIG. 4. A variety of project information can be displayed and captured under the project details tab 420. For example, the project details tab 420 can include key project information such as project scope, details, and notes. The data contained within the project details tab 420 can be viewed, entered, edited, deleted, and appended by the user or the project management and ranking system 204, at which time the project ranking application 126 analyzes the data and adjusts the project ranking accordingly.

On the viewer's bottom right side of the project details form 400 are the project categories 421. A variety of project information can be displayed and captured under the project categories 421. For example, the project categories 421 can include one or many construction site types. The data contained within the project categories 421 can be viewed, entered, edited, deleted, and appended by the user or the project management and ranking system at which time the project ranking application 126 analyzes the data and adjusts the project ranking accordingly.

In the middle of the project details form 400 are two tabs: a project management tab 430 and a results tab 432, the project management tab 430 being selected for display in FIG. 4. A variety of project management information can be displayed and captured under the project management tab 430. For example, the project management tab 430 can include commands, fields, and notes that facilitate the workflow and the user while processing the project. These fields and commands can include project priority, deactivation, status, to-dos, processing status, territory, responsible, market research analyst, salesperson, data source, related projects, and analyst comments. The data contained within the project management tab 430 can be viewed, entered, edited, deleted, and appended by the user or the project management and ranking system at which time the project ranking application 126 analyzes the data and adjusts the project ranking accordingly.

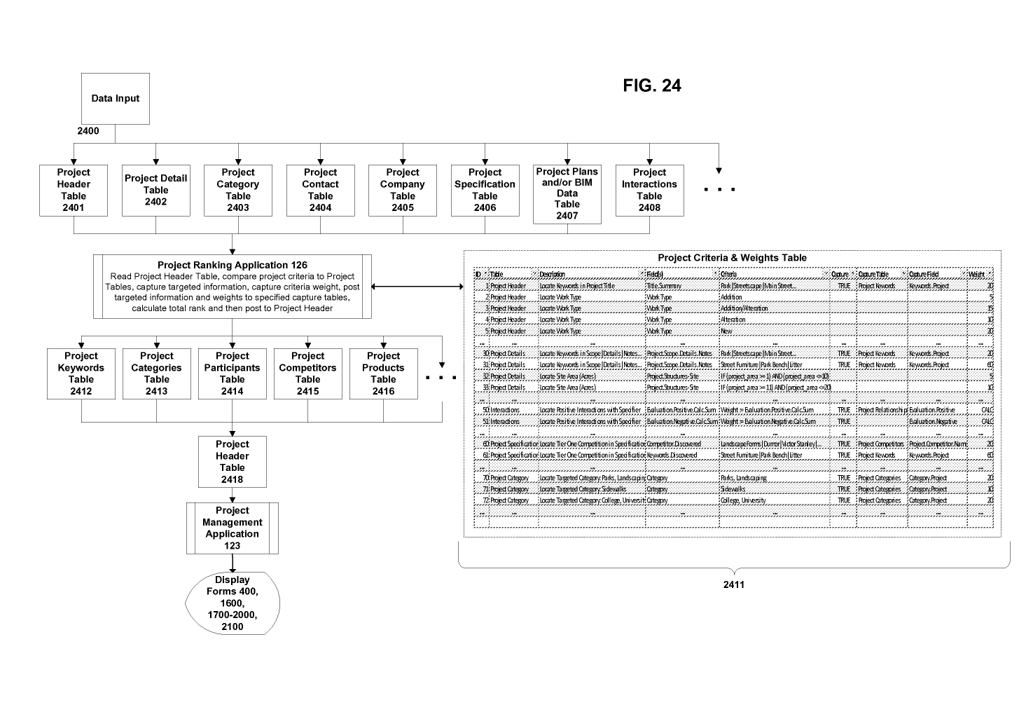

On the right side of the project details form 400 is the project ranking scoreboard 440. A variety of project analysis results, project criteria, and weight totals processed by the project ranking application 126 can be displayed under the project ranking scoreboard 440. For example, the project ranking scoreboard 440 can include one or more project criteria and weights results derived from the project workflow and ranking application in conjunction with customizable algorithm configurations set within the project criteria and weights table 2411, as discussed hereinafter in connection with FIG. 24. The project criteria and weights results can include project target prospects, valuation, categories, specifications targeted, keywords located in the project details/scope/notes, manufacturers (competitors) located in specifications, keywords located in specifications, positive and/or negative interactions, past purchasing decisions, location site area, etc.

The project criteria and weights table 2411 includes project criteria and weights that are fully customizable by the user and can be tailored to the market research organization's role and the type of company served by the market research organization. These customizable algorithmic configurations and project criteria and weights are initially set up by each market research organization using a questionnaire and can be modified and tweaked over time. The questionnaire helps guide the market research organization to determine how it rates criteria found within its industry. For example, the market research organization will list all major and minor competitors, giving a numerical value to each one. A record and an algorithmic configuration are created within the project criteria and weights table 2411 for each of these competitors. Depending on how and where the project management and ranking system 204 is hosted and used, creation of the record and the algorithmic configuration can be done manually by the market research group and/or a consulting group that assists the market research organization to set up the project management and ranking system 204 and/or the construction data reporting service, or through a project management system questionnaire wizard.

As another example, the market research organization will list all major and minor industry keywords, giving a numerical value to each one. A record and an algorithmic configuration are created within the project criteria and weights table 2411 for each of these keywords. Again, depending on how and where the project management and ranking system 204 is hosted and used, creation of the record and the algorithmic configuration can be done manually by the market research group and/or the consulting group and/or the construction data reporting service, or through a project management system questionnaire wizard. In the scenario represented in the Figures, the application forms, criteria, and weights are for a market research organization for a fictitious commercial site furniture company, whereas a window manufacturer may have significantly different criteria when performing market research.

A variety of project information can be displayed and captured under the project categories 421. For example, the project categories 421 can include one or many construction site types. Some of the data contained within the project ranking scoreboard 440 can be added to the project criteria and weights table setup as well as entered, edited, deleted, and appended by the user or the project management and ranking system at which time the project ranking application 126 analyzes the data and adjusts the project ranking accordingly which in turn is displayed as the total project weight at the project ranking scoreboard 440.

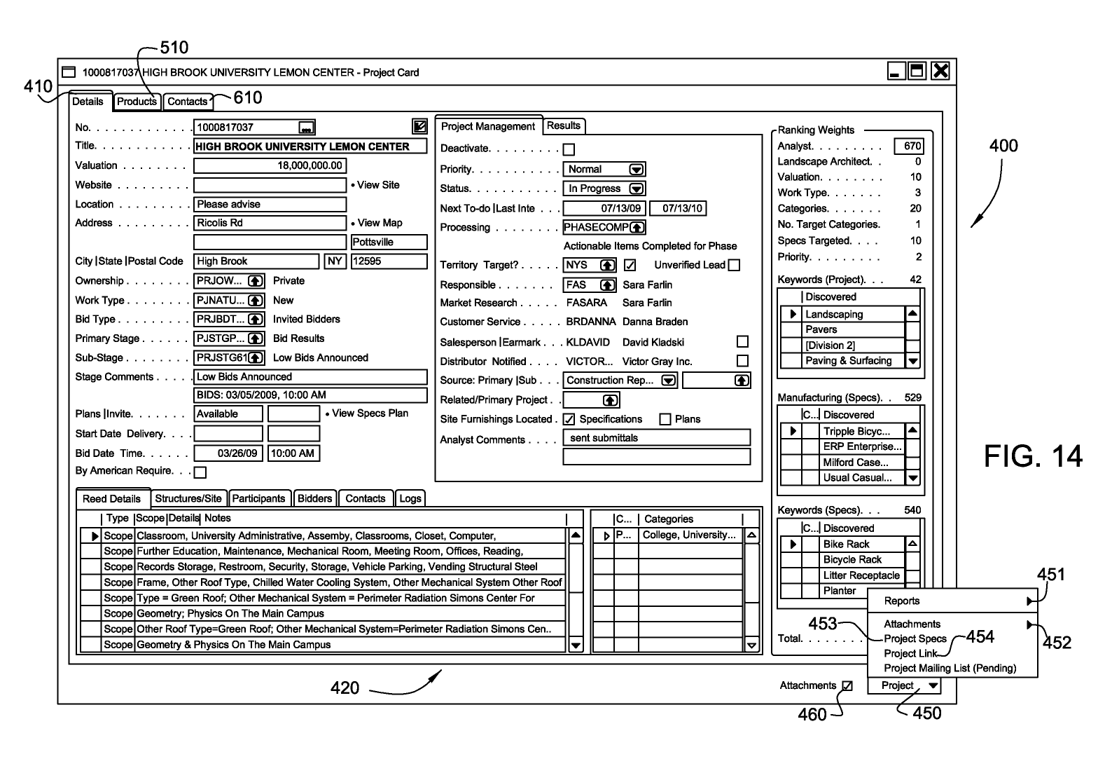

A project menu button 450 and an attachments selection box 460 are displayed at the lower right, as will be discussed in greater detail in connection with FIG. 14.

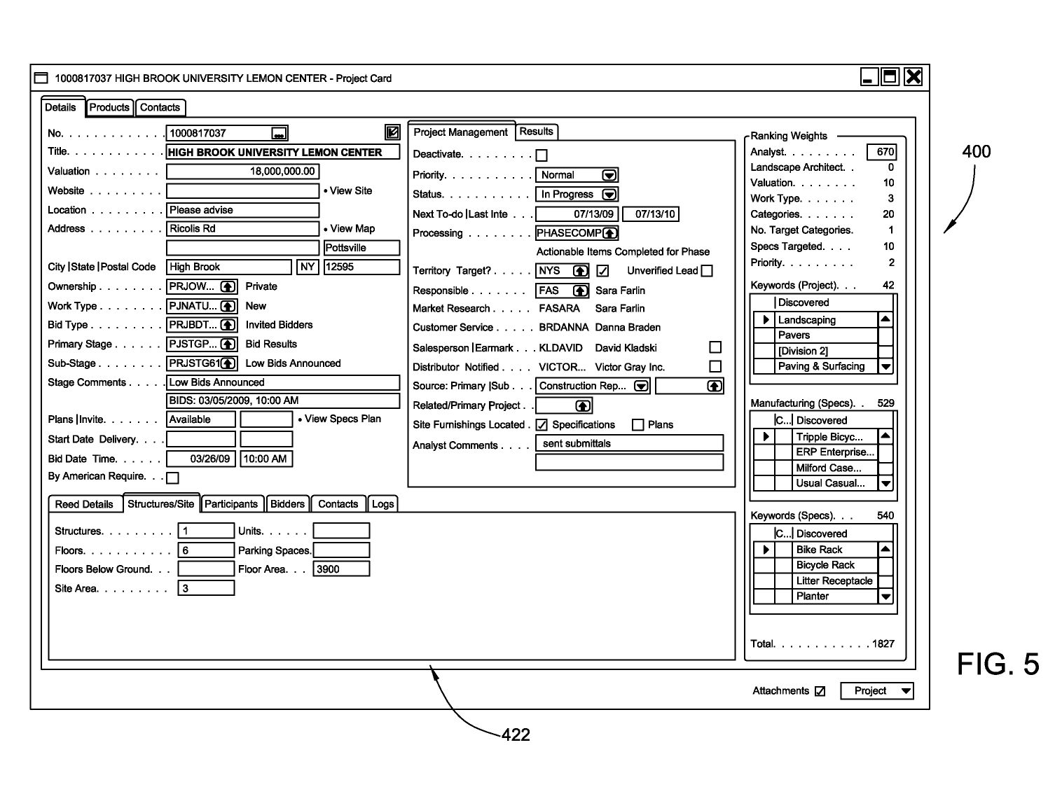

FIG. 5 shows the contents of the structures/site tab 422 in the project details form 400. A variety of project information relating to the project's site and construction can be displayed and captured under the structures and site tab 422. For example, the structures and site tab 422 can include key project structures and site information such as the number of structures, floors, floors below ground, site area, units, parking spaces, and floor area. The data contained within the structures and site tab 422 can be added to the project criteria and weights table setup as well as be viewed, entered, edited, deleted, and appended by the user or the project management and ranking system at which time the project ranking application 126 analyzes the data and adjusts the project ranking accordingly.

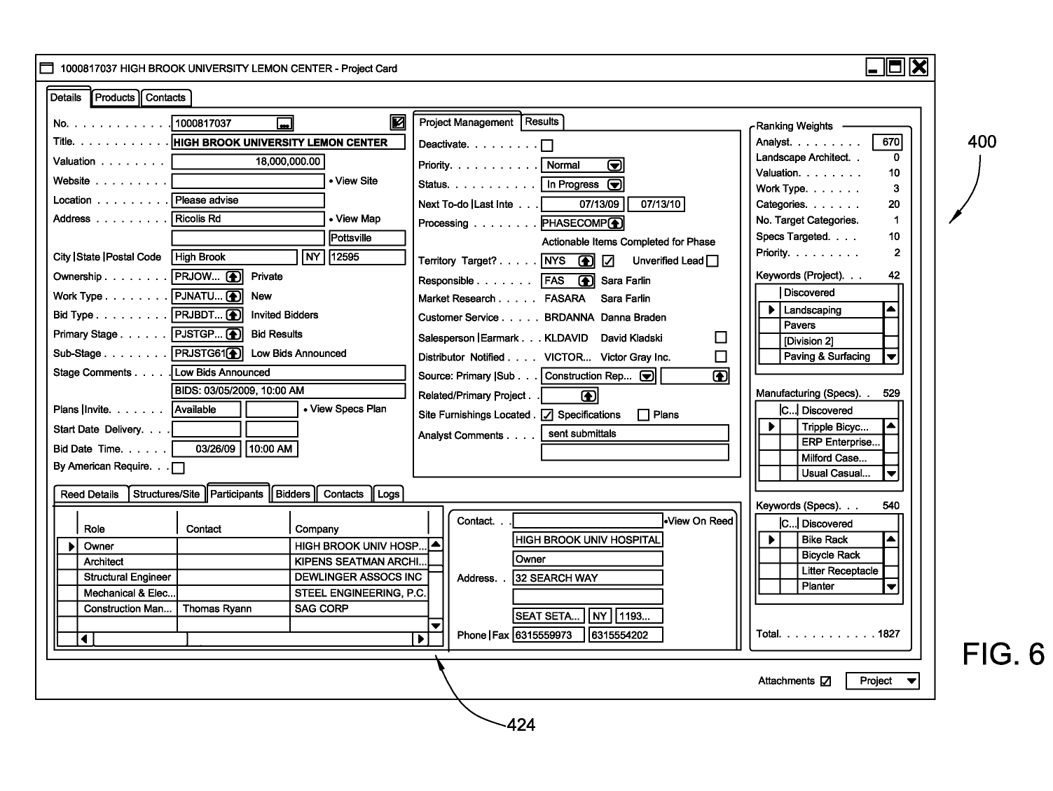

FIG. 6 shows the contents of the project participants tab 424 in the project details form 400. A variety of project participant contact information can be displayed and captured under the project participants tab 424. For example, the project participants tab 424 can include key project participants including the owner, architect, construction manager, and landscape architect along with their contact information such as address, phone number, fax, etc. The data contained within the project participants tab 424 can be added to the project criteria and weights table setup. In addition, some of the information can be viewed, entered, edited, deleted, and appended by the user or the project management and ranking system 204 at which time the project ranking application 126 analyzes the data and adjusts the project ranking accordingly.

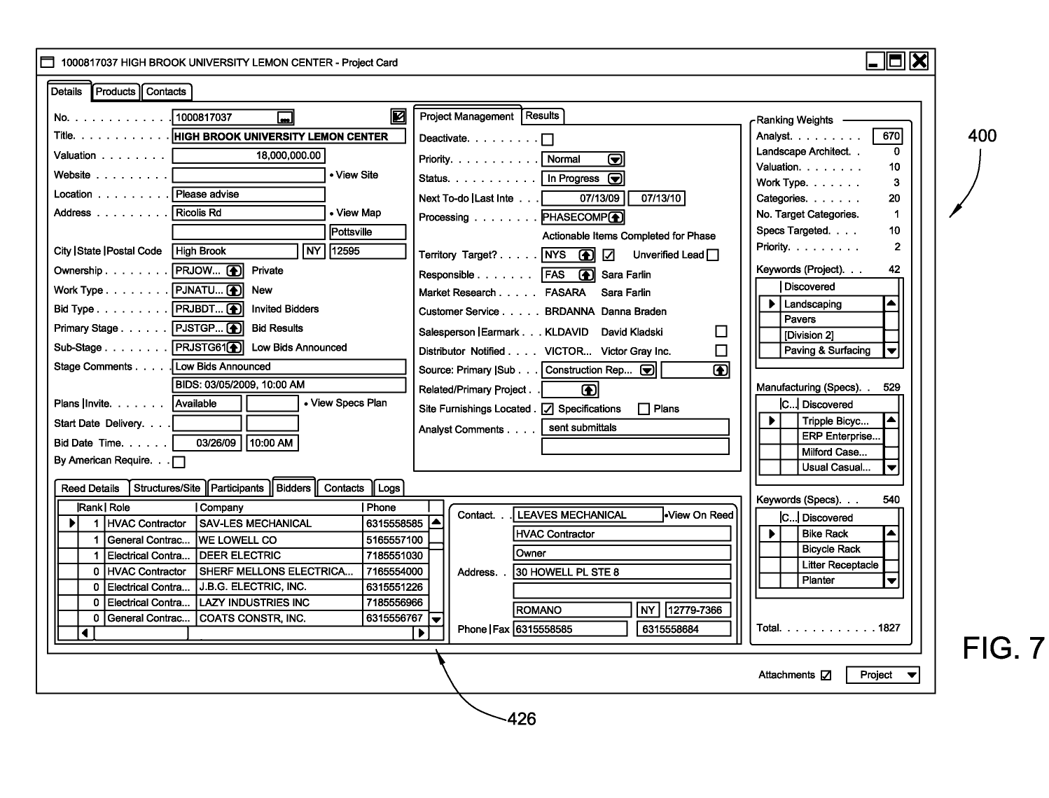

FIG. 7 shows the contents of the project bidders tab 426 in the project details form 400 showing the contents of the project bidders tab 426. A variety of project bidder contact information can be displayed and captured under the project bidders tab 426. For example, the project bidders tab 426 can include project bidder contact information such as address, phone number, fax, etc. The data contained within the project bidders tab 426 can be added to the project criteria and weights table setup. In addition, some of the information can be viewed, entered, edited, deleted, and appended by the user or the project management and ranking system 204 at which time the project ranking application analyzes the data and adjusts the project ranking accordingly.

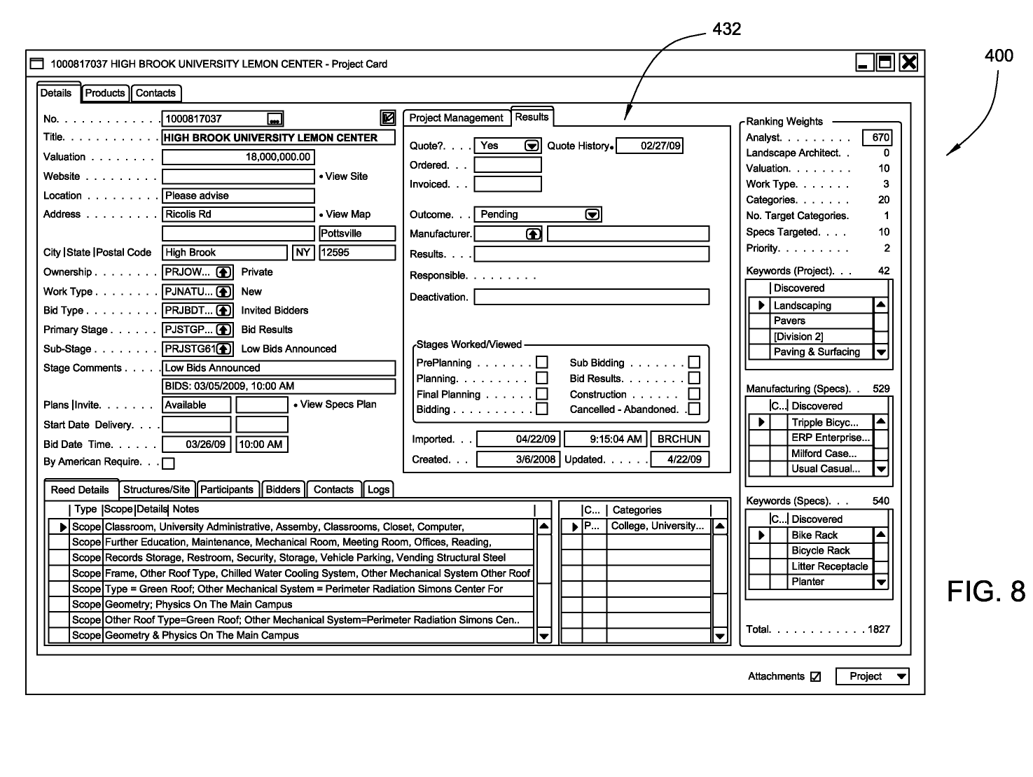

FIG. 8 shows the contents of the project results tab 432 in the project details form 400. A variety of automatically captured project results and information can be displayed and captured under the project results tab 432. For example, the project results tab 432 can include which competitor was awarded the project, project deactivation comments, milestone dates for quotations, order and invoicing, stage milestones and history, metadata, project information, outcome, etc.

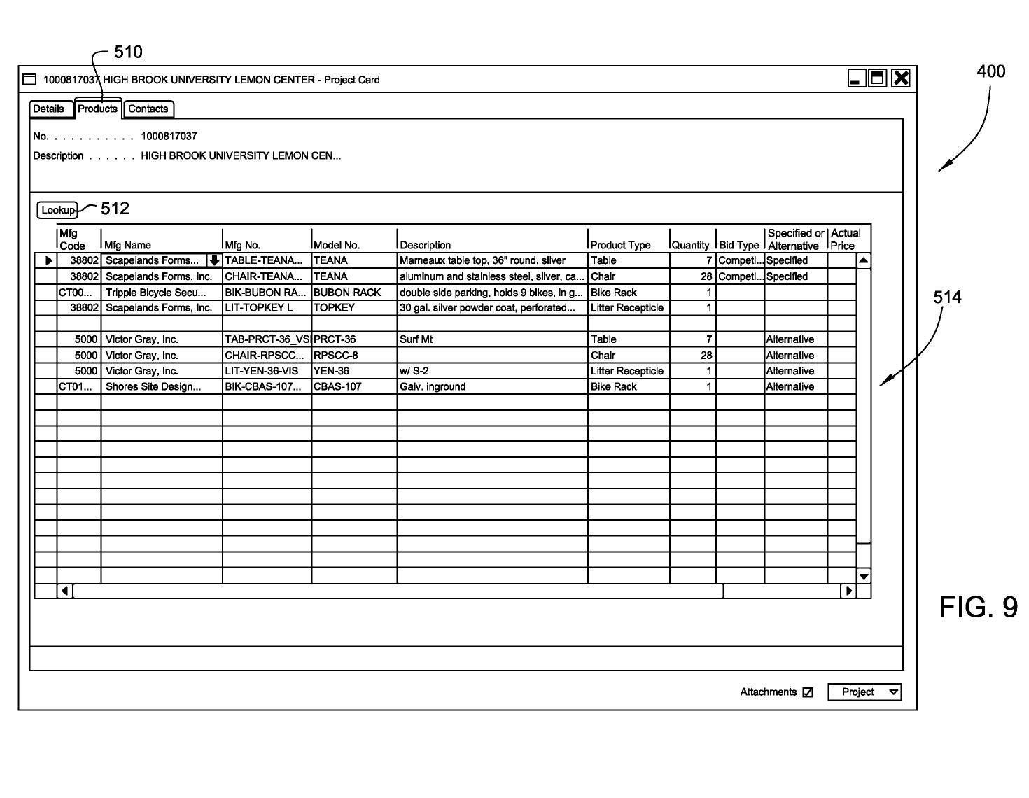

FIG. 9 shows the contents of the project products tab 510 in the project details form 400. A variety of competitive information can be displayed and captured under a project products list 514. For example, the project products list 514 can include manufacturer (competitor) name, product model number, description, product type, quantity, bid type, located in the site plans and/or project specifications, known price and indicator for whether the product was specified or an alternative. A lookup button 512 allows quick access to production information for the active product line through a search engine. The data contained within the project products list 514 can be added to the project criteria and weights table setup. In addition, some of the information can be viewed, entered, edited, deleted, and appended by the user or the project management and ranking system 204 at which time the project ranking application 126 analyzes the data and adjusts the project ranking accordingly.

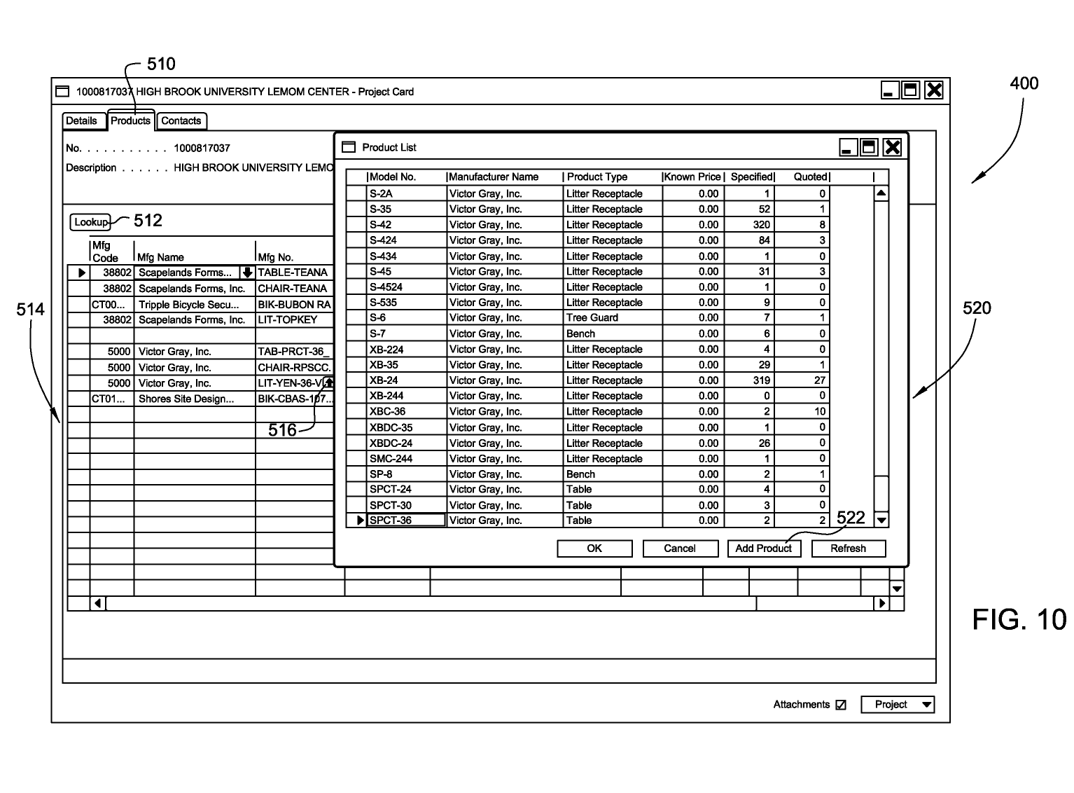

FIG. 10 is a detailed section of the project details form 400 showing a project products listing and selection form 520 displayed by the project management application 123 after the user activates a model number lookup button 516 associated with each of the model numbers in the project products list 514. A variety of competitive information can be displayed, captured, created, and selected using the project products listing and selection form 520. For example, the project products listing and selection form 520 can include manufacturer name (the manufacturer may be a competitor), product model number, product type, total quantity specified, total quantity quoted, and known price.

An add product button 522 in the project products listing and selection form 520 allows quick creation of product records not currently included in the project products listing and selection form 520. The data contained within the project products listing and selection form 520 can be added to the project criteria and weights table setup. In addition, some of the information can be viewed, entered, edited, deleted, and appended by the user or the project management and ranking system 204 at which time the project ranking application 126 analyzes the data and adjusts the project ranking accordingly.

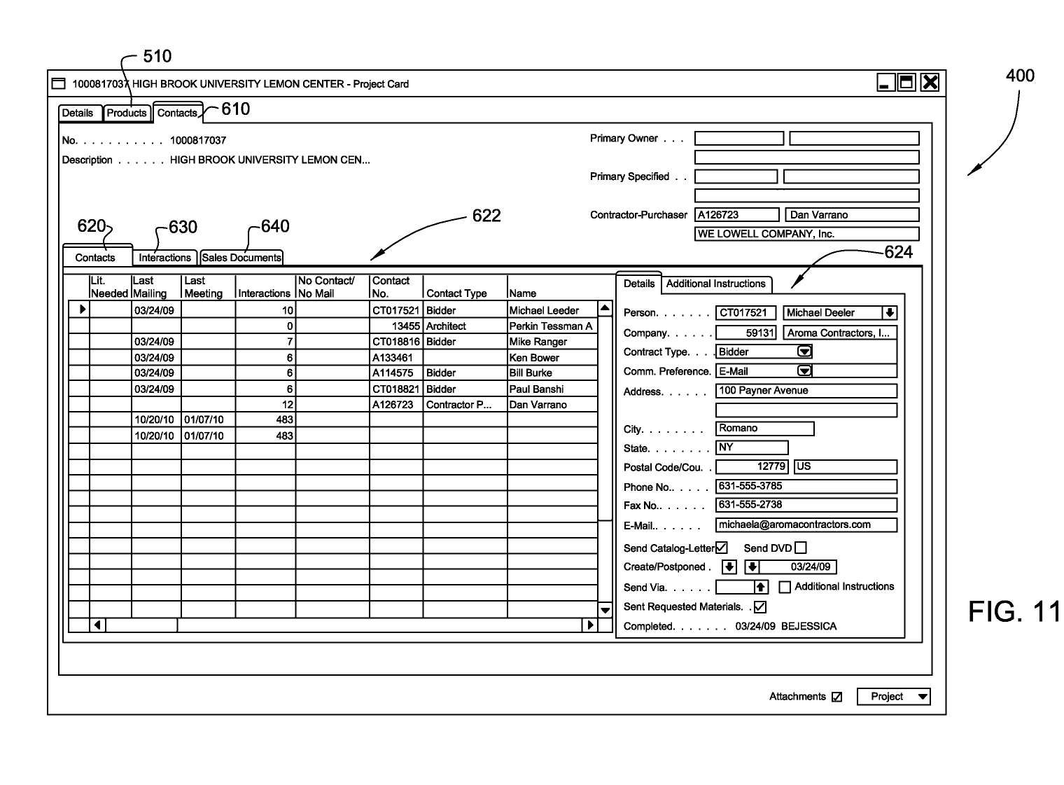

FIG. 11 shows the contents of the project contacts tab 610 in the project details form 400. Three tabs are included in the project contacts tab: a contacts tab 620, an interactions tab 630, and a sales documents tab 640. A variety of project participant contact information can be displayed, captured, created, linked, and selected using the project contacts form 620. The project contacts tab 620 includes a project contacts form 622 that can be used to capture, isolate, organize and then link the targeted prospects located partially from the contacts listed on FIG. 6 the project participants tab 424 and FIG. 7 project bidders tab 426, as well as from other contact resources and research. In addition, contacts added to the project contacts form 622 can easily take advantage of the automatic mailing queue functions and direct access to the contact's interactions using a project contacts details tab 624 included in the project contacts form 622.

The data contained within the project contacts form 622, as well as the project contacts details tab 624, can be added to the project criteria and weights table setup. In addition, some of the information can be viewed, entered, edited, deleted, and appended by the user or the project management and ranking system 204 at which time the project ranking application 126 analyzes the data and adjusts the project ranking accordingly.

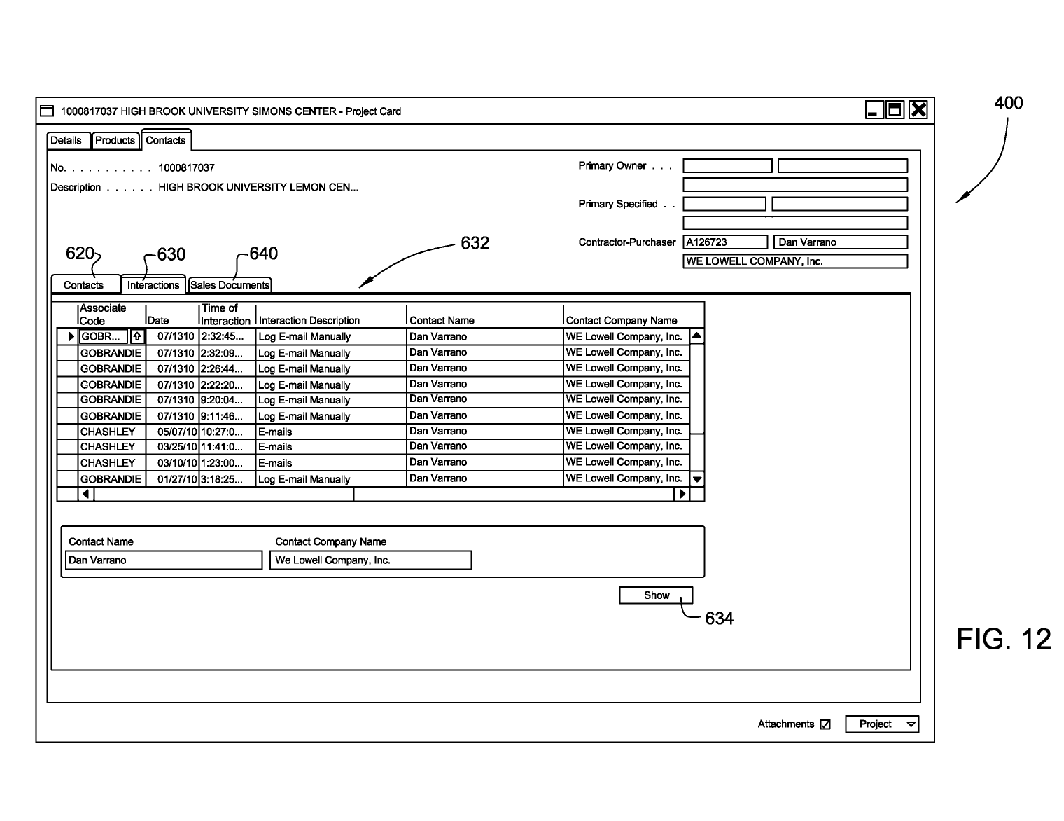

FIG. 12 shows the contents of the project interactions tab 630 in the project details form 400. The contents of the project interactions tab 630 include a project contact interaction history log 632. In addition, the details within each interaction in the project contact interaction history log 632 can be displayed using the show button 634.

The data contained within the project interactions form 632 can be added to the project criteria and weights table setup. In addition, some of the information can be viewed, entered, edited, deleted, and appended by the user or the project management and ranking system 204 at which time the project ranking application 126 analyzes the data and adjusts the project ranking accordingly.

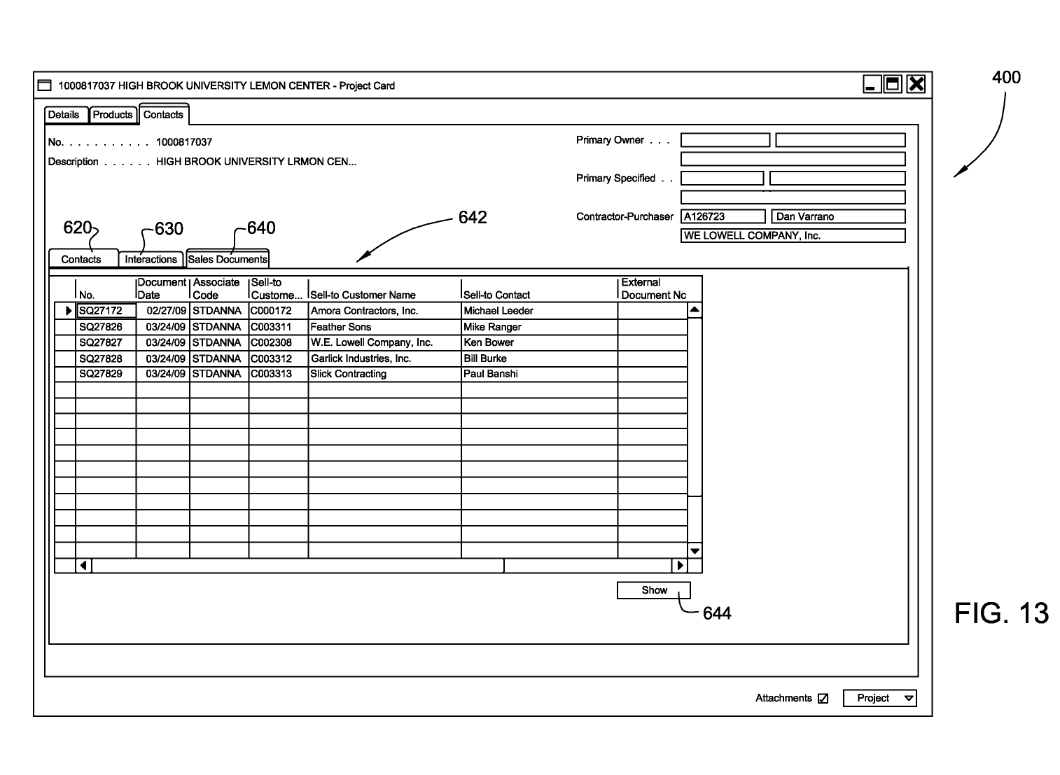

FIG. 13 shows the project details form 400 in which the project sales documents tab 640 is selected. The contents of the project sales documents tab 640 include a project sales document history log 642. In addition, the details within each sales document listed in the project sales document history log 642 can be displayed using the show button 644.

FIG. 14 is a detailed section of the project details form 400 showing the project menu button 450 and the menu displayed when the user selects the project menu button. The menu includes project reports 451, file attachments 452, project specifications directly from the construction reporting service 453, project reports and site plans directly from the construction reporting service 454, etc., any of which can be accessed when selected by the user. The attachments checkbox 460 indicates to the user if there are files attached to the project.

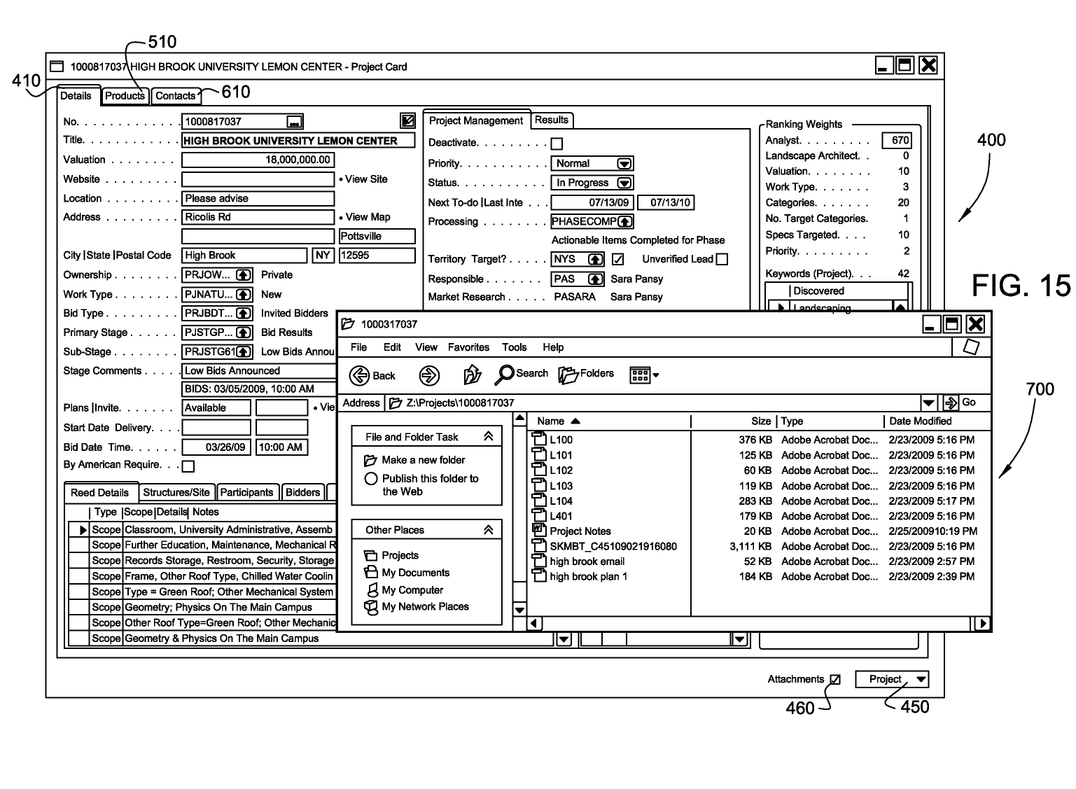

By selecting the project menu button 450, then selecting attachments 452 from the project menu, the user is presented with access to the project file directory 700 that stores files associated with the project, as shown in FIG. 15.

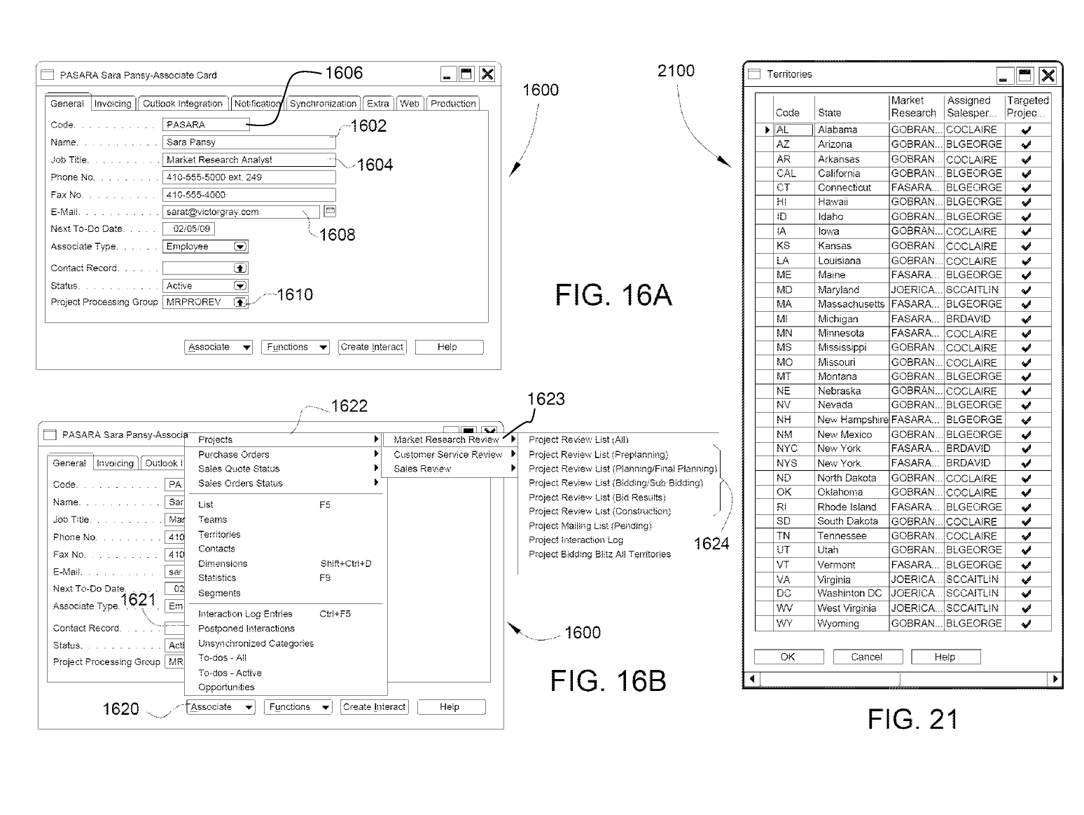

FIGS. 16A and 16B show a project user form 1600, which includes an example of a market research analyst record 1600 for a market research user. The project user form 1600 provides access to the assigned real-time, workable, and prioritized direct marketing to-do list (project workflow and ranking forms 1700, 1800, 1900, and 2000) used by the market research analyst to process each project through each construction stage directed by the target marketing process illustrated in FIG. 2.

The market research analyst can display, enter, edit, delete, or append a variety of user information relating to the market research analyst's role within the market research organization, as well as user preferences and configurations, using the project user form 1600. For example, the project user form 1600 includes a name field 1602, a title field 1604, a code (system identification) field 1606, an email address field 1608, and a project processing group field 1610. The code field 1602 is used to identify the user, restrict his or her access, and tailor his or her experience based on his or her territories and role within the market research organization.

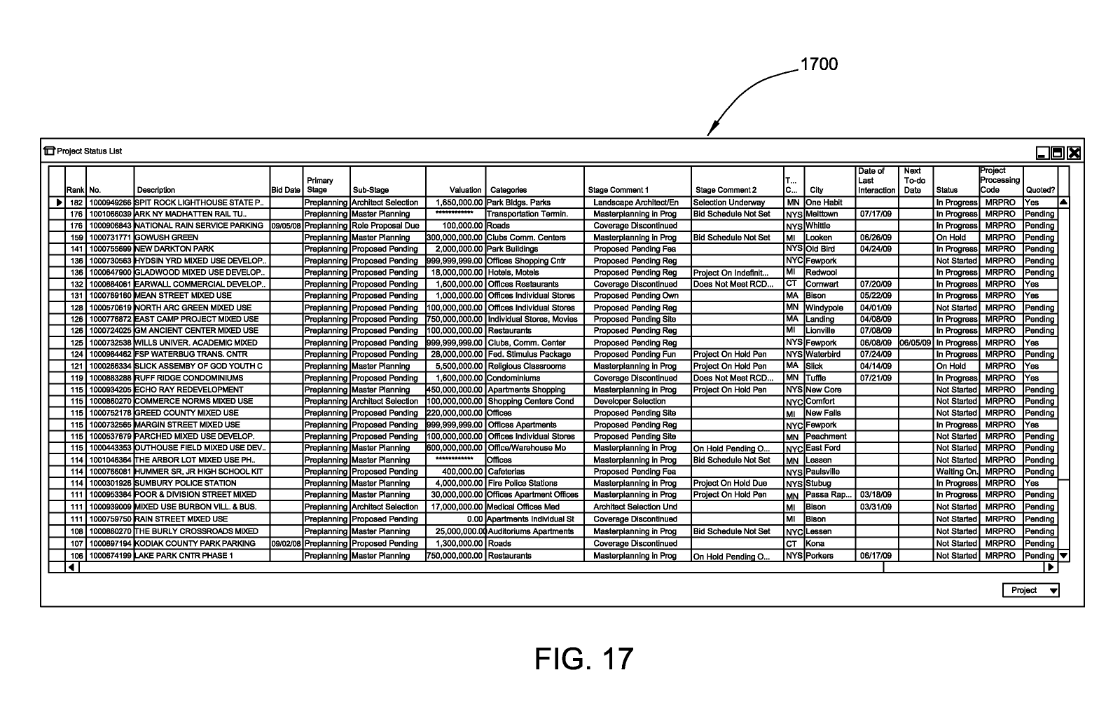

An associate menu button 1620 allows the market research analyst to bring up an associate menu 1621, then select projects 1622, then select market research review 1623, which brings up a list of menu options (project gateways), segregated by the primary construction stages, each with a link 1624 to the project workflow and ranking forms 1700, 1800, 1900, and 2000 shown respectively in FIGS. 17-20.

FIGS. 17-20 show example project workflow and ranking forms 1700, 1800, 1900, and 2000 for a market research organization for a fictitious commercial site furniture company, which can be displayed in the graphical user interface of the user's PC. They include example construction project records for a market research user to process in descending order from the highest ranking project to the lowest ranking project.

The project workflow and ranking form 1700 is used in the preplanning stage 205. The project workflow and ranking form 1800 is used in the planning and schematics and final planning and design development stages 215 and 216. The project workflow and ranking form 1900 is used in the bidding and sub-bidding stages 225 and 228. The project workflow and ranking form 2000 is used in the bid results and construction stages 231 and 234. All of the project workflow and ranking forms 1700, 1800, 1900, and 2000 include the tools necessary to access the construction project data using the project details form 400 (FIG. 4) while processing the project through the primary stages of construction using the target marketing process of FIG. 2.

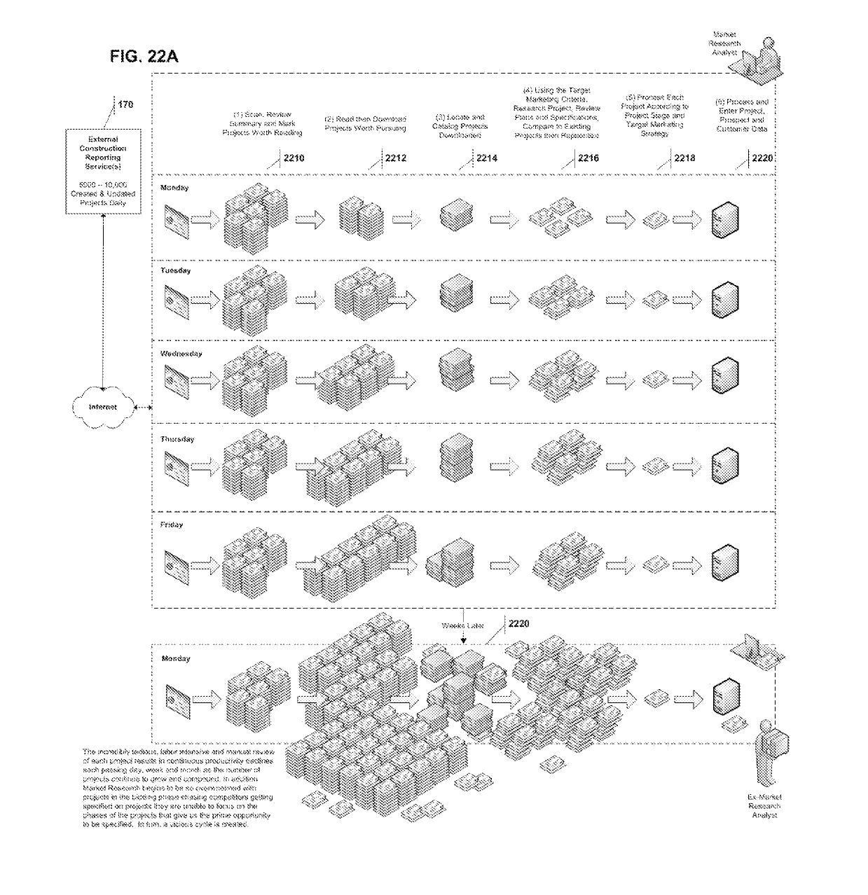

FIG. 21 is a section of a project territory form 2100, which includes market research territory records assigned to individual market research users. The project territory form 2100 is only used when assigning territories to the market research analysts. The information stored within the project territory form 2100 controls what is displayed to each of the market research analysts on the other forms 400, 1700, 1800, 1900, and 2000. In particular, the project territory form 2100 works in conjunction with the project user form 1600 (FIGS. 16A and 16B), the project details form 400 (FIG. 4), and the project workflow and ranking forms 1700, 1800, 1900, and 2000 (FIGS. 17-20) by narrowing down the projects that display for the market research analysts. The data contained within project territory form 2100 can be added to the project criteria and weights table setup. In addition, some of the information can be viewed, entered, edited, deleted, and appended by the user or the project management and ranking system 204, at which time the project ranking application 126 analyzes the data and adjusts the project ranking accordingly.

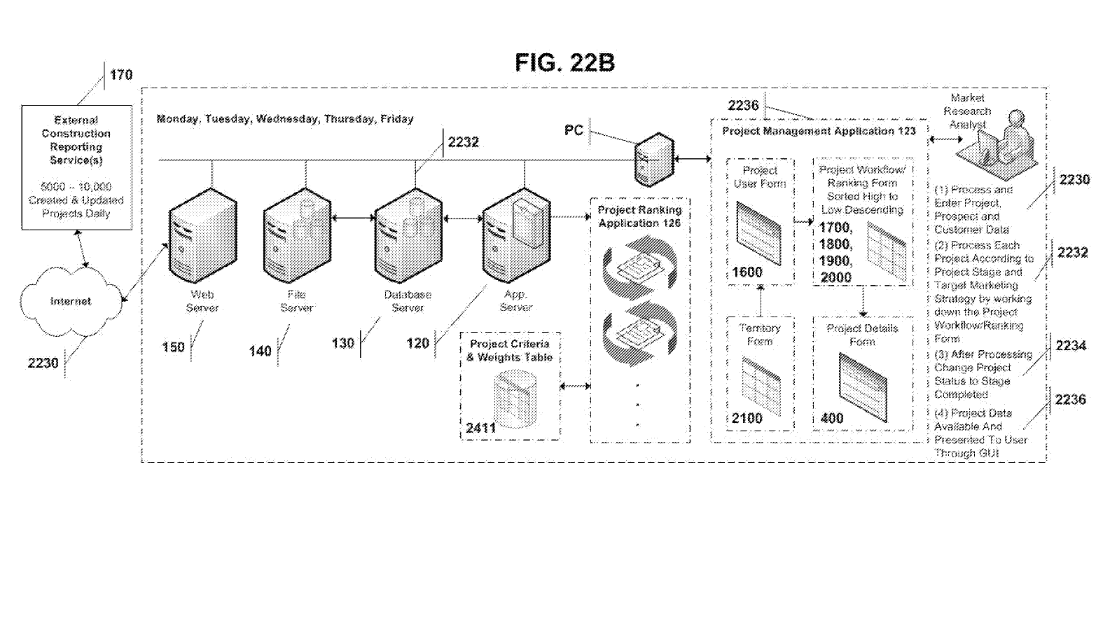

FIGS. 22A and 22B are diagrammatic comparisons between the conventional method of targeting, processing, and managing construction project leads and reports for the purpose of target marketing products, versus the method of targeting, processing, and managing construction project leads and reports using the tools provided by the invention.

FIG. 22A illustrates a week in the life of a market research analyst targeting, processing, and managing external construction project lead reports for the purpose of target marketing products.

Keeping in mind that construction reporting services typically process, create and update 5000 to 10,000 projects domestically each day, each morning the market research analyst logs onto the construction reporting services' websites 170 and then begins the extremely tedious and labor intensive manual review of each project in various forms of summary and detail reviews.

Starting with Monday:

Step 1 (2210) generally comprises the market research analyst scanning through long lists of projects, first by narrowing them down by primary construction phase and then by reading through the summary or title of each project, looking for criteria that might ultimately be met by his or her employer's products at some point during the construction phase. Then the market research analyst begins marking the projects worth reading thoroughly. The market research analyst continues this process through each of the remaining project stages, including preplanning, planning and schematics, final planning and design development, bidding, sub-bidding, bid results, construction, and project cancellation, all while trying to look for and recognize projects on which he or she has previously worked.

Step 2 (2212) generally comprises the market research analyst downloading, saving, and/or printing and then reading each project that at first glance appeared to be worth reading, while trying to look for and recognize projects on which that he or she has previously worked.

Step 3 (2214) generally comprises the market research analyst locating and cataloging the projects downloaded, while trying to look for and recognize projects on which he or she has previously worked.

Step 4 (2216) generally comprises the market research analyst using his or her knowledge, past experience, and target marketing criteria to research each project further, review the plans and specifications, compare the current project with existing projects, and in turn reprioritizing the catalog in some working order or priority.

Step 5 (2218) generally comprises the market research analyst processing each project according to the project stage and target marketing strategy. By the time the market research analyst has reached this step, the workday is just about over and he or she typically can only begin a few projects before having to move on to the next step.

Step 6 (2220) generally comprises the market research analyst processing each project through a customer relationship management system (which has built into it some level of project management software capabilities) linking the day's work, prospect information, and interactions. The stacks of cataloged and prioritized projects worth pursuing, which are still unprocessed, are left to process at some point in the future, maybe the next day.

Tuesday:

The market research analyst logs onto the construction reporting services' websites 170 and then begins his or her day, repeating steps 1-6 from Monday. The result is the same as Monday: a few projects are processed fully, and the stacks of unprocessed projects that are worth pursuing, cataloged, and prioritized, grow and are left to be processed at some point in the future, maybe the next day.

Wednesday:

The market research analyst logs onto the construction reporting services' websites 170 and then begins his or her day, repeating steps 1-6, with the same result as Monday and Tuesday.

Thursday:

The market research analyst logs onto the construction reporting services' websites 170 and then begins his or her day, repeating steps 1-6, with the same result as Monday, Tuesday, and Wednesday.

Friday:

The market research analyst logs onto the construction reporting services' websites 170 and then begins his or her day, repeating steps 1-6 with the same result as Monday, Tuesday, Wednesday, and Thursday.

Weeks Later:

The extremely tedious and labor intensive manual review of each project results in continuous productivity declines each passing day, week, and month as the number of projects continues to grow and compound. In addition, Market Research begins to be so overwhelmed with projects in the bidding phase, and chasing competitors getting specified on projects, that the market research analysts are unable to focus on those phases of the projects that give their employer the best opportunity to get specified. In turn, a vicious cycle is created (2222), because the tools provided to manufacturers (for example) by service providers focus primarily on bidding, the urgency to respond to the bids is overwhelming, causing manufacturers to overlook the first three project stages, such that they experience a drop in projects in which they are specified and have to chase competitors that are being specified.

FIG. 22B is a pictorial representation of a week in the life of a market research analyst targeting, processing, and managing external construction project lead reports for the purpose of target marketing products, using the tools provided by the invention.

Project Management and Ranking System's Perspective

There will now be described from the project management and ranking system's perspective how the system tirelessly, quickly, and accurately processes 5000 to 10,000 domestic projects each work day (Monday, Tuesday, Wednesday, Thursday and Friday) through all of the primary project stages shown in FIG. 2, including planning and schematics 215, final planning and design development 216, bidding 225, sub-bidding 228, bid results 231, and construction 234. The project management and ranking system 204 eliminates the extremely tedious and labor intensive manual review of each project, and continuous productivity declines, and increases the number of projects that do get processed every day.

In Step 1 (2230), the project lead data 203 is downloaded through a data connection from at least one project lead service 170 and/or manually entered by an end user using the project management application 123, as shown in FIG. 1. Downloading is carried out either in response to an end user command to download the raw data from the project lead service's FTP site; or automatically, at predetermined time intervals, under the control of a computer application hosted either at the project lead service or at the end user's site.

In Step 2 (2232), where the downloading application is hosted at the end user's site, the downloaded data 203 is imported into the project management database 134 stored in a database server 130, as shown in FIG. 1. Where the downloading application is hosted at the project lead service 170, the downloaded data is linked to the project management database 134.

In Step 3 (2234), the adding, importing, changing, and/or deleting of project data (2232) triggers the project ranking application 126 to analyze the data, compare the data to the project criteria and weights, adjust the project ranking, and update the project records accordingly. The adding, importing, changing, and/or deleting of project data is carried out by the construction reporting service and/or the market research analyst while processing each project using the target marketing process illustrated in FIG. 2.

In Step 4 (2236), the project data is available and presented to the user through the graphical user interface as project user forms 1600, project workflow and ranking forms 1700, 1800, 1900, and 2000, territory forms 2100, and project details forms 400.

The system repeats steps 1-4 each work day (Monday, Tuesday, Wednesday, Thursday, and Friday).

User's Perspective

Referring now to both FIG. 2 and FIG. 22B, which is a flowchart diagram of an organization's target marketing processes enabled by aspects of the invention, there is now described the events of Monday, Tuesday, Wednesday, Thursday and Friday from the user's perspective:

Keeping in mind that construction reporting services typically process, create and update 5000 to 10,000 projects domestically each day, each morning the market research analyst logs onto the project management application 123 (step 204 in FIG. 2), accesses the project user form 1600, and begins processing each project according to the system-determined priority order (step 2230. The market research analyst works down the project workflow and ranking form 1700, 1800, 1900, or 2000 in descending order from the highest ranking project to the lowest ranking project, while processing the project using the project details form 400 in conjunction with the target marketing process as described above with respect to FIG. 2 (step 2232).

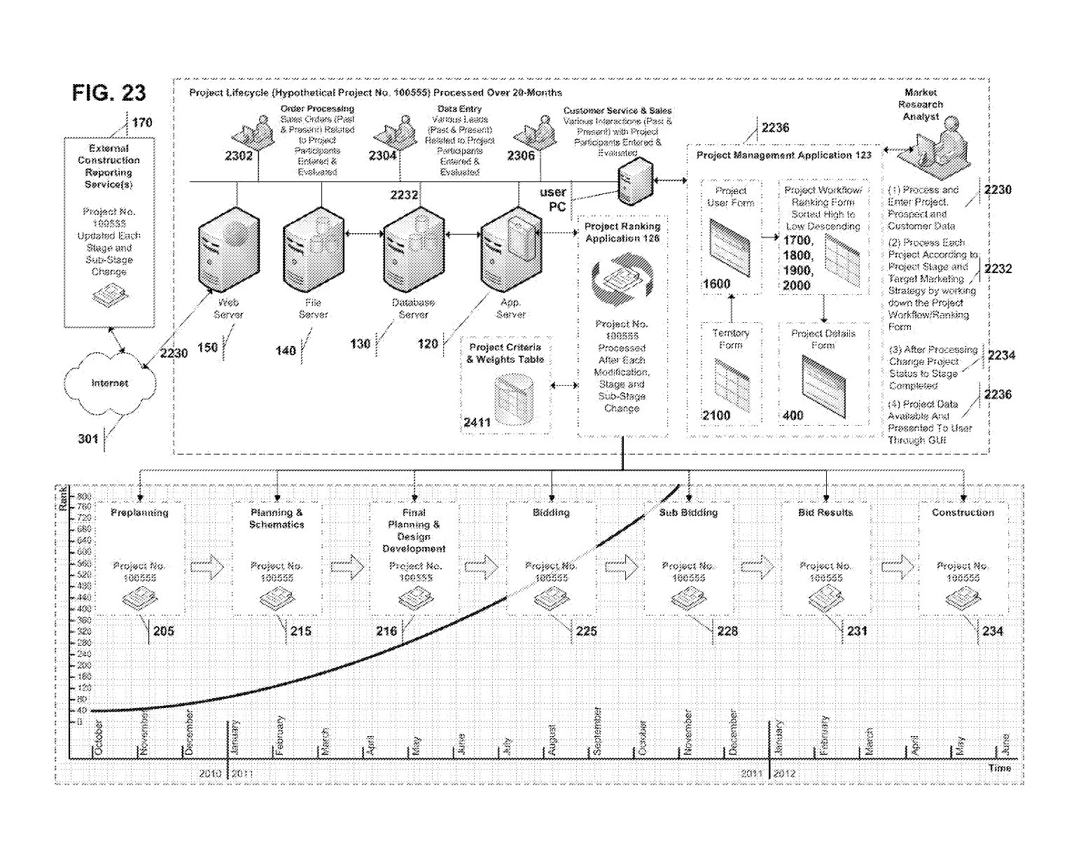

FIG. 23 is a project lifecycle and ranking change diagram showing a hypothetical project being processed over 20 months and how (with reference to the accompanying graph) the project ranking application 126 increases and/or decreases the rank of each project (shown as y-axis of the graph) as it moves along in time (shown as the x-axis of the graph) while data continues to be added, modified, analyzed, and processed by the market research organization and/or the user groups outside of the market research organization and/or the construction data reporting service 170, using the target marketing workflow process enablement layer 330 throughout the lifecycle of the project.

There is now described from the perspective of the project management and ranking system 204 how the system tirelessly, quickly and accurately processes 5000 to 10,000 domestic projects each day (Monday, Tuesday, Wednesday, Thursday and Friday) through all of the primary project stages including planning and schematics 215, final planning and design development 216, bidding 225, sub-bidding 228, bid results 231, and construction 234. The project management and ranking system 204 eliminates the extremely tedious and labor intensive manual review of each project, and continuous productivity declines, and increases the number of projects that do get processed every day and determines the projects with the highest probability of requiring a company's products and/or services.

As described previously, the construction reporting services 170 typically process, create, and update 5000 to 10,000 projects domestically each day, and then post the resulting project data to their web sites.

Step 1 (2230): the project lead data is downloaded through a data connection from at least one construction reporting service 170 and/or manually entered by an end user using the project management application 123. Downloading is carried out either in response to an end user command to download the raw data from the project lead service's FTP site; or automatically, at predetermined time intervals, under the control of a computer application hosted either at the project lead service or at the end user's site.

Step 2 (2232): where the downloading application is hosted at the end user's site, the downloaded data is imported into the project management database 134 stored in the project management database server 130. Where the downloading application is hosted at the project lead service, the downloaded data is linked to the project management database 130.

Step 3 (2234): the process of adding, importing, changing, and/or deleting project data triggers the project ranking application 126 to analyze the data, compare the data to the project criteria and weights, adjust the project ranking, and update the project records accordingly. For example, the construction reporting services 170 continuously add statuses, contacts, and project details to the project record over time. As this information is brought into the project management database 134 and then analyzed by the project ranking application 126, the project ranking application 126 adjusts the rank based on the criteria, weights, and algorithms in the project criteria and weights table 2411 (shown in FIG. 24). The adjustment of the rank by the project ranking application 126 can occur as different departments within an organization interact with the same project participants as the market research organization. Whether they are related to the same project or not, these interactions with user groups outside the market research organization can also be rated and included in the ranking of present and future projects. These departments and interactions can include, but are not limited to, a customer service providing a sales quote or providing details about a specific product, a data entry processing sales leads coming in through the various prospect and customer channels, a salesperson logging his or her recent meeting with a prospect, and an order processing person processing an order with one of the project participants.

Other user group systems outside the market research organization—including but not limited to order processing 2302 (which can include processing an order with one of the project participants), data entry 2304 (which can include processing sales leads coming in through the various prospect and customer channels), and customer service and sales 2306 (including a sales representative providing a sales quote or details about a specific product, or logging his or her recent meeting with a prospect)—may interact with the same project participants as the market research organization. Whether they are related to the same project or not, these interactions with user group systems outside the market research organization can also be rated and taken into account by the project ranking application 123 with respect to of present and future projects, depending on the project criteria and weights in the project criteria and weights table 2411. Therefore, these other user group systems also can be linked to the project ranking and management system 204 and to the files stored on the file server 140.

Step 4 (2236): the project data is available and presented to the user as project user forms 1600, project workflow and ranking forms 1700, 1800, 1900, and 2000, and project details forms 400.

Each time the project is updated by the external construction reporting service 170, and as the project moves through the construction stages 205, 215, 216, 225, 228, 231, and 234, the project management application 123 presents the market research analyst with the project on his or her project workflow and ranking form 1700, 1800, 1900, and 2000 as he or she works down the project workflow and ranking list form 1700, 1800, 1900, and 2000 in descending order from the highest ranking project to the lowest ranking project, while processing the project using the project details form 400 in conjunction with the target marketing process illustrated in FIG. 2.

Over time, the project management and ranking system 204 processes the project as it moves through the construction stages of preplanning 205, planning and schematics 215, final planning and design development 216, bidding 225, sub-bidding 228, bid results 231, and construction 234. In parallel, external data sources and other user groups 2302, 2304, 2306, as mentioned above, the project ranking application 126 increases and/or decreases the project ranking depending on the project criteria and weights assigned by the company served by the market research organization and the relationship of the company to the project.

FIG. 24 is a data flow diagram representing the flow of data through the system and how the system determines how to rank the projects.

Block 2400 represents data input from the various external data sources 170′ (including the construction reporting services 170 and project and customer channels, as shown in FIG. 3), and other user group systems (including but not limited to order processing 2302, data entry 2304, and customer service and sales 2306). Blocks 2401-1208, 2411, and 2418 represent the main project tables stored within the project management database 134 hosted on the database server 130. These tables store the data accessed, added, and imported through the various project forms and used by the market research analyst.

Blocks 2412-2416 represent the main data capture tables stored within the project management database 134 hosted on the database server 130.

The process of adding, importing, changing and/or deleting project data 2400 triggers the project ranking application 126 to read in the various project tables 2401-2408, analyze the data 2400 by comparing it to the project criteria and weights table 2411, capturing and logging targeted information (the information derived from the questionnaire, incorporated into the algorithm, and captured for data mining purposes) and the criteria and weights to the project data capture tables 2412-2417, adjusting the project ranking, and updating the project header table 2418 accordingly. Once the project ranking application 126 has completed processing, the project management application 123 prepares the project data 2400 to be available and presents the data 2400 to the user as the project user forms 1600, project workflow and ranking forms 1700, 1800, 1900, and 2000, and project details forms 400.

The project criteria and weights table 2411 is fully customizable and can be tailored to the market research organization's role and company type. In this scenario, the application forms, criteria, and weights are for a market research organization for a fictitious commercial site furniture company, whereas a window manufacturer may have significantly different criteria when performing market research.

The project ranking application 126 includes program instructions that are executed by the processor in the application server 120 to enable the system 110 to learn from previous targeted projects using conventional machine learning techniques. The program instructions for machine learning capture the project criteria from the previous targeted projects, look for patterns, and update the project criteria and numerical weights accordingly. Thus, over time, the system 110 learns from successfully and unsuccessfully targeted projects by capturing the criteria from these projects, looking for patterns, and updating the project criteria and weights table 2411 accordingly.

Modifications and variations of the above-described embodiments of the present invention are possible, as appreciated by those skilled in the art in light of the above teachings. For example, although the present invention is described in the context of construction data, it can be used to analyze any data stream. For example, a search engine such as Google can capture data for everyone tracking washing machine products online and sell that data to an appliance retailer. The present invention can then be used by the appliance retailer (or by the entity that administers the search engine) to sort the data to identify which online shoppers had inquired multiple times, had also bought a house, or otherwise have some characteristic that increases the probability that they will purchase a major appliance. It is therefore to be understood that, within the scope of the appended claims and their equivalents, the invention may be practiced otherwise than as specifically described.

What is claimed is:

1. A computer system for enabling real-time analysis and workflow management of marketing efforts targeting a plurality of projects for a user organization, wherein each of the projects has a lifecycle with multiple stages and each of the projects has project data associated therewith, the system comprising:
memory having program instructions for performing market research analysis and reporting, customer relationship management, project management, sales and marketing, project workflow, and project ranking operations for the projects, corresponding to the stages of the lifecycles of the projects;
input means for receiving, entering, and editing the project data, customizable project criteria for use in analyzing the project data, and customizable numerical weights applied to the project criteria for ranking the importance of the project criteria to the user organization, wherein the numerical weights are based on the importance of the project criteria to the user organization;
storage means for storing the project data, the project criteria, and the weights; and
at least one processor to execute the program instructions for performing the market research analysis and reporting, customer relationship management, project management, sales and marketing, project workflow, and project ranking operations for the projects, corresponding to the stages of the lifecycles of the projects, wherein the operations include:
accepting input including the entering and editing of project data, project criteria, and numerical weights applied to the project criteria, and the designation of a project as inactive;
in response to the entering and editing of project data, calculating total weights for each of the projects in real time based on the numerical weights applied to the project criteria, and ranking the projects based on the total weights to identify projects having the highest business value to user organization and to prioritize and sequence the projects in working order accordingly; and
generating displays of at least some of the project data and the ranking for the projects that are not designated as inactive.

2. The computer system of claim 1, wherein the operations executed by the at least one processor further includes, in response to input from a user designating a project as inactive, hiding the project data and ranking for the designated project, until the project data for the designated project is updated.

3. The computer system of claim 1, wherein the editing of project data includes deleting and appending.

4. The computer system of claim 1, wherein in the operation of generating displays, at least some displays include commands and fields for facilitating workflow and processing of the projects by the user.

5. The computer system of claim 1, wherein the memory further has program instructions for learning from previous targeted projects by capturing the project criteria from the previous targeted projects, looking for patterns, and updating the project criteria and numerical weights accordingly, and wherein the at least one processor executes the program instructions for learning from previous targeted projects.

6. A method for enabling real-time analysis and workflow management of marketing efforts targeting a plurality of projects for a user organization, using the computer system of claim 1, comprising the steps of:
accepting input including the entering and editing of project data, project criteria, and numerical weights applied to the project criteria, and the designation of a project as inactive;
in response to the entering, and editing of project data, calculating total weights for the projects based on the numerical weights applied to the project criteria and ranking of the projects based on the total weights to identify projects having the highest probability of requiring the user organization's products and/or services and having the highest return for the user organization; and
generating a display of at least some of the project data and the ranking for each of the projects.

7. The method of claim 6, comprising the further step of, in response to input from a user, hiding the project data and ranking for a project designated as inactive, until the project data for the specified project is updated.

8. The method of claim 6, comprising the further step of learning from previous targeted projects by capturing the project criteria from the previous targeted projects, looking for patterns, and updating the project criteria and numerical weights accordingly.

9. A computer program product residing on a computer readable medium comprising instructions for causing a computer to carry out the method of claim 6.

10. A method for displaying real-time analysis and workflow information of marketing efforts targeting a plurality of projects for a user organization, using a graphical user interface generated by the computer system of claim 1, the method comprising the steps of:
receiving project data at the processor, through a data connection;
displaying the graphical user interface on an electronic display device via a client device;
displaying, via the graphical user interface, a project details form that permits a user to access applications corresponding to the program instructions and market research information appropriate for the user's role, and to process projects through the stages of their lifecycle in conjunction with viewing, entering, and editing the project data, project criteria, and numerical weights associated with the projects, and analyzing the project data associated with the projects;
displaying, via the graphical user interface, a set of project workflow and ranking forms permitting a user to access data associated with the projects using the project details form and to process projects through the stages of their lifecycle based on the ranking of the projects by the at least one processor; and
displaying, via the graphical user interface, a set of project user forms providing a user access to the project workflow and ranking forms.

11. A computer program product residing on a computer readable medium comprising instructions for causing a computer to carry out the method of claim 10.
